(19) United States
(12) Patent Application Publication
(10) Pub. No.: US 2003/0215257 A1
(43) Pub. Date: Nov. 20, 2003

(54) Process cartridge and electrophotographic image forming apparatus

(75) Inventors: Toshiyuki Karakama, Shizuoka (JP); Kazushi Watanabe, Shizuoka (JP); Kazuhide Kudo, Shizuoka (JP); Ryuta Murakami, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/207,081

(22) Filed: Jul. 30, 2002

(30) Foreign Application Priority Data
May 17, 2002 (JP) 142267/2002(PAT.
Jul. 12, 2002 (JP) 204342/2002(PAT.

(51) Int. Cl. G03G 15/00; G03G 21/16

(52) U.S. Cl. 399/90; 399/111

(57) ABSTRACT

This process cartridge comprises a frame body, a cartridge electrical contact, and a pushed portion provided on the frame body. The process cartridge is detachably attached to a main body of an electrophotographic image forming apparatus comprising a main body electrical contact, and main body pushing means. When the process cartridge is attached to the main body of the electrophotographic image forming apparatus, it is possible to achieve electrically strong connection of the cartridge electrical contact to the main body electrical contact by the pushed portion being pushed by the main body pushing means. Owing to this simple structure, it is possible to realize the electrical connection of the cartridge electrical contact to the main body electrical contact.

### BACKGROUND OF THE INVENTION

1. Filed of the Invention

The present invention relates to a process cartridge, which can be detached from or attached to a main body of an electrophotographic image forming apparatus, and an electrophotographic image forming apparatus.

2. Description of Related Art

Here, the electrophotographic image forming apparatus is an apparatus of forming an image in a recording medium by using electrophotographic image forming process. Then, as examples of the electrophotographic image forming apparatus, for example, an electrophotographic copying machine, electrophotographic printers (for example, a laser beam printer, an LED printer, etc.), a facsimile machine, a word processor, and the like are included.

In addition, the process cartridge is a cartridge that is made by integrating charging means, developing means, or cleaning means, which are process means, and electrophotographic photosensitive body, and enables this cartridge to be detached from or attached to a main body of the electrophotographic image forming apparatus. Furthermore, the process cartridge is a cartridge that is made by integrating at least one of charging means, developing means, and cleaning means, which are process means, and an electrophotographic photosensitive body, and enables the cartridge to be detached from or attached to a main body of the electrophotographic image forming apparatus, and a cartridge that is made by integrating at least developing means, which is process means, and an electrophotographic photosensitive body, and enables the cartridge to be detached from or attached to a main body of the electrophotographic image forming apparatus.

Conventionally, what is adopted in an electrophotographic image forming apparatus using electrophotographic image forming process is a process cartridge system where electrophotographic photosensitive body and process means acting on the electrophotographic photosensitive body are made to be a cartridge by being integrated, and this cartridge is enabled to be attached to or detached from a main body of the electrophotographic image forming apparatus. Since it is possible to maintain the apparatus by a user without maintenance personnel according to this process cartridge system, it is possible to increase operability sharply. Then, this process cartridge system is widely used in electrophotographic image forming apparatuses.

In addition, in recent years, products where memory (memory element) storing various service information and process information is installed in each cartridge are realized. In the electrophotographic image forming apparatuses, by utilizing the memory information in this cartridge, image quality and maintenability of the cartridge are further enhanced. Then, there are some each of which is performing electric communication with memory of a cartridge by being electrically connected to a connector provided in a main body of the electrophotographic image forming apparatus.

However, if a conventional contact type connector is used, in order to realize a secured electrical connection, there is a possibility that the communication structure of a main body of an electrophotographic image forming apparatus and a contact portion of memory in a cartridge may become complicated.

The present invention is made in view of the unsolved subjects that conventional technology has.

### SUMMARY OF THE INVENTION

An object of the present invention is to provide a process cartridge and an electrophotographic image forming apparatus, where an electrical contact portion of the process cartridge can be electrically connected to a main body electrical contact of the electrophotographic image forming apparatus in simple structure.

Another object of the present invention is to provide a process cartridge and an electrophotographic image forming apparatus, where a main body electrical contact, provided in a main body of the electrophotographic image forming apparatus, can be electrically connected to a cartridge electrical contact portion surely and stably when the process cartridge is attached to the above-described main body of the electrophotographic image forming apparatus.

Still another object of the present invention is to provide a process cartridge and an electrophotographic image forming apparatus, where a main body electrical contact, provided in a main body of the electrophotographic image forming apparatus, can abut on a cartridge electrical contact without contacting to a frame body of the process cartridge, and a main board except the cartridge electrical contact when the process cartridge is attached to the above-described main body of the electrophotographic image forming apparatus.

In addition, a further object of the present invention is to provide a process cartridge and an electrophotographic image forming apparatus that are actually miniaturized and space-saved.

Furthermore, a still further object of the present invention is to provide a process cartridge and an electrophotographic image forming apparatus, where a main body electrical contact, provided in a main body of the electrophotographic image forming apparatus, can be electrically connected to a cartridge electrical contact portion surely and stably in the condition that the process cartridge is attached in an attachment position of the above-described main body of the electrophotographic image forming apparatus.

Moreover, another object of the present invention is to provide a process cartridge and an electrophotographic image forming apparatus, where the accuracy of a position where a main body electrical contact, provided in a main body of the electrophotographic image forming apparatus, abut on a cartridge electrical contact portion in the condition that the process cartridge is attached to the above-described main body of the electrophotographic image forming apparatus, is good.

In addition, still another object of the present invention is to provide a process cartridge and an electrophotographic image forming apparatus, where a main body electrical contact, provided in a main body of the electrophotographic image forming apparatus, can smoothly contact onto a cartridge electrical contact portion without a shock when the process cartridge is attached to the main body of the electrophotographic image forming apparatus.

Furthermore, a further object of the present invention is to provide a process cartridge that is detachable from a main body of an electrophotographic image forming apparatus that has a main body electrical contact and main body pushing means, comprising:

an electrophotographic photosensitive body drum;

process means of acting on the electrophotographic photosensitive body drum;

a frame body;

a memory element storing information;

a cartridge electrical contact portion that is electrically connected to the memory element, and is electrically connected to the main body electrical contact when the process cartridge is attached to the main body of the electrophotographic image forming apparatus;

a main board that is provided in the frame body, and has the memory element and the cartridge electrical contact portion; and

a pushed portion that is provided in the frame body, and in which the main body electrical contact and the cartridge electrical contact portion are pushed in the direction of being electrically connected by the main body pushing means when the process cartridge is attached to the main body of the electrophotographic image forming apparatus.

Moreover, a still further object of the present invention is to provide a process cartridge that is detachable from a main body of an electrophotographic image forming apparatus that has a main body electrical contact and a main body abutting-member, comprising:

an electrophotographic photosensitive body drum;

process means of acting on the electrophotographic photosensitive body drum;

a frame body;

a memory element storing information;

a cartridge electrical contact portion that is electrically connected to the memory element, and is electrically connected to the main body electrical contact when the process cartridge is attached to the main body of the electrophotographic image forming apparatus;

a main board that is provided in the frame body, and has the memory element and the cartridge electrical contact portion;

a cartridge abutting portion that is provided in the same side as the main board with projecting from the frame body, and guides the main body electrical contact to the cartridge electric contact portion with contacting to the main body abutting member when the process cartridge is attached to the main body of the electrophotographic image forming apparatus; and

an inclined plane that is provided in an upstream side of the cartridge abutting portion in a attachment direction in which the process cartridge is attached to the main body of the electrophotographic image forming apparatus, and serves to electrically connect the main body electrical contact, guided by the main body abutting member, to the cartridge electrical contact portion when the process cartridge is attached to the main body of the electrophotographic image forming apparatus.

In addition, another object of the present invention is to provide an electrophotographic image forming apparatus that has a detachable process cartridge and forms an image in a recording medium, comprising:

(i) a main body electrical contact;

(ii) main body pushing means;

(iii) attachment means for detachably attaching a process cartridge comprising: an electrophotographic photosensitive body drum; process means of acting on the electrophotographic photosensitive body drum; a frame body; a memory element storing information; a cartridge electrical contact portion that is electrically connected to the memory element, and is electrically connected to the main body electrical contact when the process cartridge is attached to the main body of the electrophotographic image forming apparatus; a main board that is provided in the frame body, and has the memory element and the cartridge electrical contact portion; and a pushed portion that is provided in the frame body, and in which the main body electrical contact and the cartridge electrical contact portion are pushed in the direction of being electrically connected by the main body pushing means when the process cartridge is attached to the main body of the electrophotographic image forming apparatus; and

(iv) conveying means for conveying the recording medium.

Furthermore, still another object of the present invention is to provide an electrophotographic image forming apparatus that has a detachable process cartridge and forms an image in a recording medium, comprising:

(i) a main body electrical contact;

(ii) a main body electrical contact supporting member that supports the main body electrical contact;

(iii) a main body abutting portion provided in the main body electrical contact supporting member;

(iv) attachment means for detachably attaching a process cartridge comprising: an electrophotographic photosensitive body drum; process means of acting on the electrophotographic photosensitive body drum; a frame body; a memory element storing information; a cartridge electrical contact portion that is electrically connected to the memory element, and is electrically connected to the main body electrical contact when the process cartridge is attached to the main body of the electrophotographic image forming apparatus; a main board that is provided in the frame body, and has the memory element and the cartridge electrical contact portion; a cartridge abutting portion that is provided in the same side as the main board with projecting from the frame body, and guides the main body electrical contact to the cartridge electric contact portion with contacting to the main body abutting member when the process cartridge is attached to the main body of the electrophotographic image forming apparatus; and an inclined plane that is provided in an upstream side of the cartridge abutting portion in a attachment direction in which the process cartridge is attached to the main body of the electrophotographic image forming apparatus, and serves to electrically connect the main body electrical contact, guided by the main body abutting member, to the cartridge electrical contact portion when the process cartridge is attached to the main body of the electrophotographic image forming apparatus; and

(v) conveying means for conveying the recording medium.

### BRIEF DESCRIPTION OF THE DRAWINGS

FIG. 1 is a vertical sectional view showing an image forming apparatus according to a first embodiment;

FIG. 2 is a sectional view showing a process cartridge in FIG. 1;

FIG. 3 is an exploded perspective view showing the process cartridge in FIG. 2;

FIG. 4 is an exploded perspective view with decomposing the process cartridge in FIG. 2 and viewing it from another direction;

FIG. 5 is a perspective view in view of the process cartridge in FIG. 2 from a left side;

FIG. 6 is a perspective view in view of the process cartridge in FIG. 2 from a right side;

FIG. 7 is a perspective view showing a memory tag;

FIG. 8 is a perspective view showing a state where a memory tag is attached to a process cartridge;

FIG. 9 is a perspective view showing a memory tag;

FIG. 10 is a perspective view showing a state where a memory tag is attached to a process cartridge;

FIG. 11 is a side view showing the allocation of a memory tag and a connector;

FIG. 12 is an enlarged perspective view showing the allocation of a memory tag and a connector;

FIG. 13 is a perspective view showing a connector;

FIG. 14 is a side view showing a connector;

FIG. 15 is a perspective view showing attachment guide means in the right side of a main body of an image forming apparatus;

FIG. 16 is a perspective view showing attachment guide means in the left side of a main body of an image forming apparatus;

FIG. 17 is an explanatory diagram of a laser shutter;

FIG. 18 is an explanatory diagram of a drive portion of the laser shutter;

FIG. 19 is an explanatory diagram of the allocation of a laser shutter, and is a perspective view showing the allocation of a connector, a connector holder, and a memory tag;

FIG. 20 is a perspective view showing a connector;

FIG. 21 is an enlarged perspective view showing the allocation of a memory tag and a connector;

FIG. 22 is a vertical sectional view showing a state where a connector holder guide abuts on a guide rib;

FIG. 23 is a vertical sectional view showing a state where a connector abuts on a memory tag;

FIG. 24 is a vertical sectional view showing the connector holder guide and guide rib in the state shown in FIG. 23;

FIG. 25 is a perspective view showing attachment guide means in a right side of a main body of an image forming apparatus;

FIG. 26 is a perspective view showing the attachment guide means in a left side of the main body of the image forming apparatus;

FIG. 27 is a perspective view showing a connector;

FIG. 28 is an enlarged perspective view showing the allocation of a memory tag and a connector;

FIG. 29 is a vertical sectional view showing a state where a connector holder guide abuts on a guide rib;

FIG. 30 is a vertical sectional view showing a state where a connector abuts on a memory tag;

FIG. 31 is a vertical sectional view showing the connector holder guide and guide rib in the state shown in FIG. 23;

FIG. 32 is a perspective view showing attachment guide means in the right side of a main body of an image forming apparatus;

FIG. 33 is a perspective view showing attachment guide means in the left side of a main body of an image forming apparatus;

FIG. 34 is a perspective view in view of a process cartridge from its bottom face;

FIG. 35 is a sectional view showing a process cartridge;

FIG. 36 is a perspective view in a state where a process cartridge is attached to an image forming apparatus in place;

FIG. 37 is a plan showing positional relation between a connector holder guide and a memory tag of a process cartridge; and

FIG. 38 is a vertical sectional view showing positional relation between the connector holder guide and memory tag of the process cartridge.

### DETAILED DESCRIPTION OF THE PREFERRED EMBODIMENTS

Embodiments of the present invention will be explained on the basis of drawings.

(Embodiment 1)

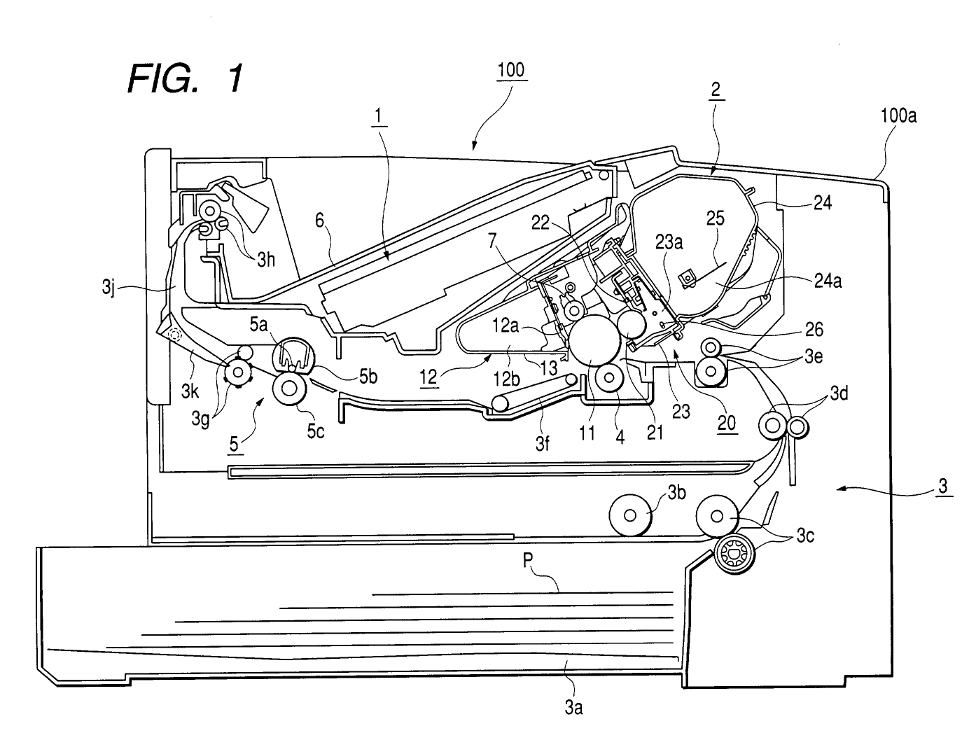

FIG. 1 shows the electrophotographic image forming apparatus according to a first embodiment. This apparatus comprises optical means 1 including a laser diode, a polygon mirror, a lens, and a reflective mirror. The optical means 1 radiates a laser beam according to image information. Owing to this, a latent image according to the image information is formed in a photosensitive body drum 11 that is an electrophotographic photosensitive body of a process cartridge 2. This latent image is developed by developing means to be made a visible image, i.e., a toner image.

(Whole Structure of Image Forming Apparatus)

Developing means that is one of process means for image formation comprises a developing roller 21 that is a developer bearing body that sends out toner to the photosensitive body drum 11, and a developing blade 22 that is a regulating member for regulating the quantity of developer adhering to a surface of the developing roller 21. In addition, by combining the developing roller 21, developing blade 22, and a development frame body 23 holding them, and a toner container 24 having a toner containing portion 24a containing the developer, a developing unit 20 that is a developing apparatus is formed.

The developing frame body 23 has a developing chamber 23a, and the toner in the toner containing portion 24a adjoining the developing chamber 23a is fed to the developing roller 21 in the developing chamber 23a by the rotation of a toner feeding member 25. The development frame body 23 comprises a toner agitating member 26, which is rotatable, near the developing roller 21, and circulates the toner in the developing chamber 23a fed out from the toner containing portion 24a. In addition, since the toner has magnetism and the developing roller 21 incorporates a stationary magnet, the toner adheres to the developing roller 21.

Then, the toner is conveyed by rotating the developing roller 21, and frictional charges charged by friction are given by the developing blade 22. In addition, a toner layer at predetermined thickness is formed on the developing roller 21, and is conveyed to a developing region of the photosensitive body drum 11. The toner supplied to this developing region is transferred to the above-described latent image on the above-described photosensitive body drum 11, and forms a toner image on the photosensitive body drum 11. In addition, the developing roller 21 is connected to a developing bias circuit provided in the main body of the image forming apparatus. Then, a developing bias voltage where a DC voltage is superimposed on an alternating voltage is usually applied.

On the other hand, a feed system 3 conveys a recording medium P, set in a sheet feeding cassette 3a, to a transfer position by a pickup roller 3b, and a set of conveying rollers 3c, 3d, and 3e with synchronizing with the formation of the above-described toner image. A transfer roller 4 serving as transfer means is arranged in the transfer position, and the toner image on the photosensitive body drum 11 is transferred to the recording medium P by applying a voltage.

The recording medium P, which is given the transcription of the toner image, is conveyed to fixing means 5 by transportation guide 3f. The fixing means 5 comprises a fixing roller 5b incorporating a drive roller 5c and a heater 5a, and fixes the toner image, which is transferred by applying heat and pressure to the recording medium P passing, on the recording medium P.

The recording medium P is conveyed by a pair of discharge rollers 3g and 3h, and is discharged to a discharge tray 6 via reversing route 3j. This discharge tray 6 is provided on an upper surface of the main body of the image forming apparatus. In addition, it is also possible to discharge the recording medium P without passing the reversing route 3j by operating a flapper 3k that can swing. Thus, convey means comprises the above-mentioned pickup rollers 3b, set of conveying rollers 3c, 3d, and 3e, conveying guide 3f, and pair of discharge rollers 3g, and 3h.

After the toner remaining on the photosensitive body drum 11 is removed by the cleaning means 12 from the photosensitive body drum 11 after the toner image being transferred to the recording medium P by the transferring roller 4, the photosensitive body drum 11 is used in subsequent image formation process. The cleaning means 12 scrapes residual toner on the photosensitive body drum 11 by a cleaning blade 12a provided with contacting to the photosensitive body drum 11, and collects the residual toner in a waste toner reservoir 12b.

(Structure of Process Cartridge)

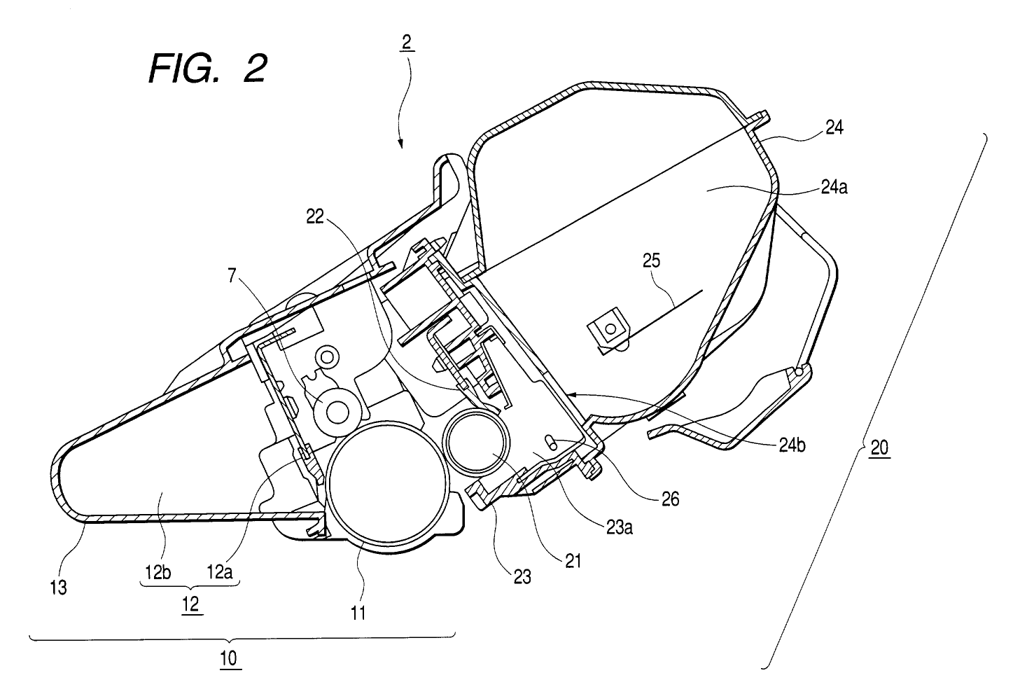

As shown in FIG. 2, the cartridge 2 comprises a developing unit 20 (developing apparatus) by welding and integrating a toner container 24 to a developing frame body 23 that supports the developing roller 21. The toner container 24 comprises a toner containing portion 24a that contains the toner, and a toner supplying opening 24b for supplying the toner in the toner containing portion 24a to the developing chamber 23a, and rotatably supports a toner feeding member 25 in the toner containing portion 24a. In addition, the toner supplying opening 24b is sealed by a developer seal (not shown) until the time when the cartridge 2 is used. Then, the toner becomes available by a user pulling the developer seal out at the first use of the cartridge 2. A developing frame body 23 supports the developing roller 21 and developing blade 22.

Moreover, a cleaning unit 10 is formed by the process cartridge 2 supporting a cleaning blade 12a, the photosensitive body drum 11, and a charging roller 7 by a drum frame body 13 that is a frame body.

Then, the cartridge 2 is made to be a cartridge by integrating the above-mentioned developing unit 20 and cleaning unit 10.

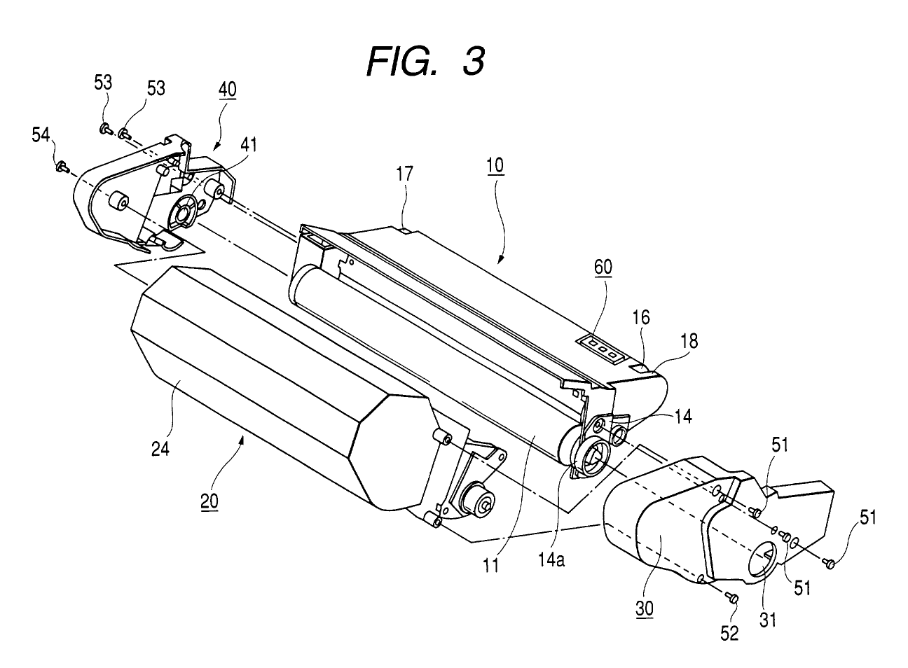

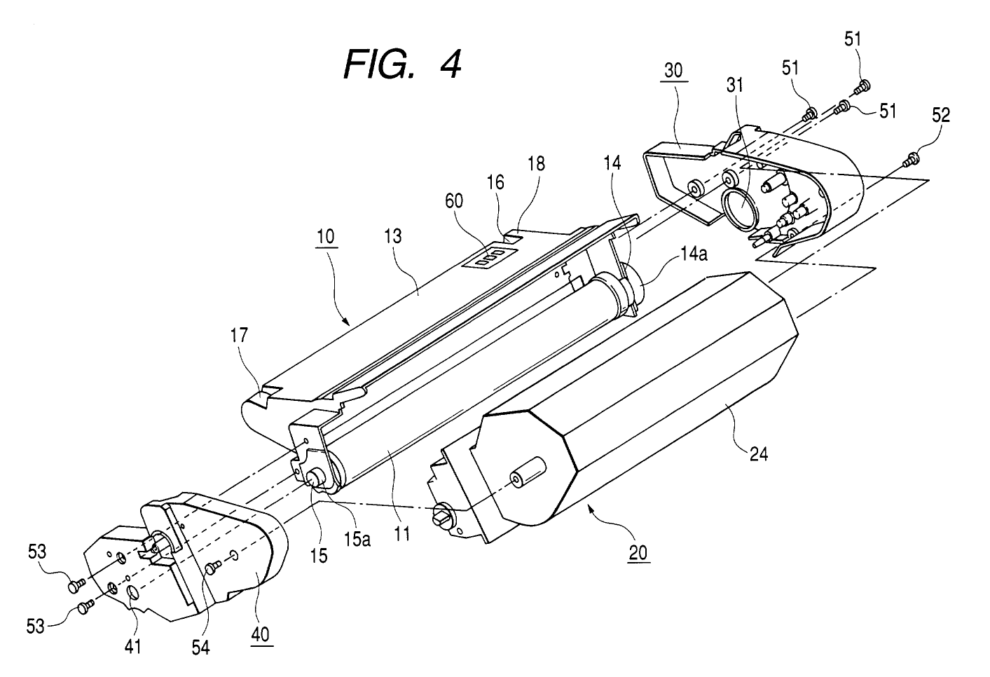

Each gear flange is installed in both ends of the photosensitive body drum 11 as shown in FIG. 3, one gear flange is rotatably supported by a drum bearing 14, and another gear flange is rotatably supported by a drum shaft 15 as shown in FIG. 4. Then, the drum bearing 14 and drum shaft 15 are installed in a drum frame body 13, and constitute the cleaning unit 10.

(Coupling of Cleaning Unit and Developing Unit)

Next, the structure of coupling the cleaning unit 10 and developing unit 20 will be explained. The cleaning unit 10 and developing unit 20 are coupled by side covers 30 and 40 on both sides respectively as shown in FIGS. 3 and 4. One side cover 30 is positioned with the cleaning unit 10 by engaging a reference hole 31 with a cylindrical portion 14a of the drum bearing 14, and is fixed with screws 51. The developing unit 20 is positioned by engaging a reference boss of the side cover 30 with a reference hole of the developing unit 20, and is fixed with screws 52 as well as the above.

Another side cover 40 is positioned with the cleaning unit 10 by engaging a reference hole 41 with a cylindrical portion 15a of the drum shaft 15 of the photosensitive body drum 11, and is fixed with screws 53. Moreover, the developing unit 20 is fixed by screws 54 as well as the other side.

(Structure of Attachment Means of Process Cartridge)

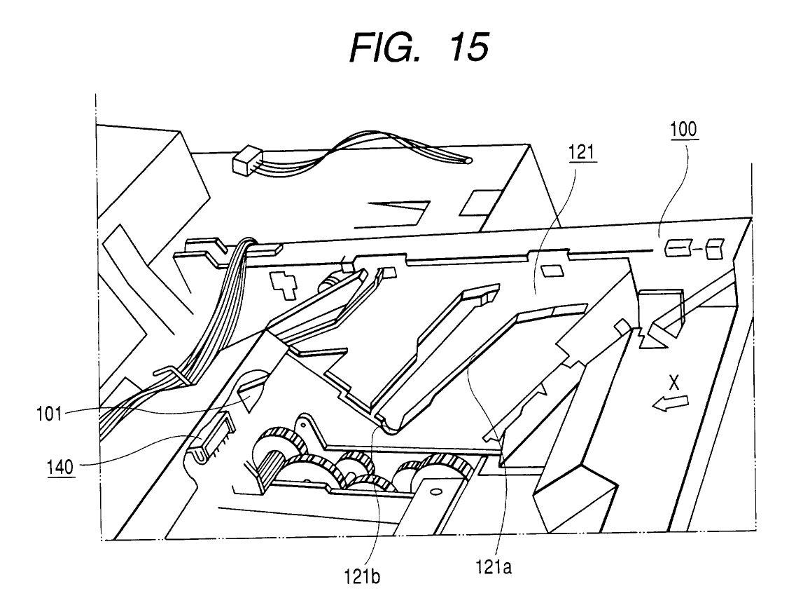

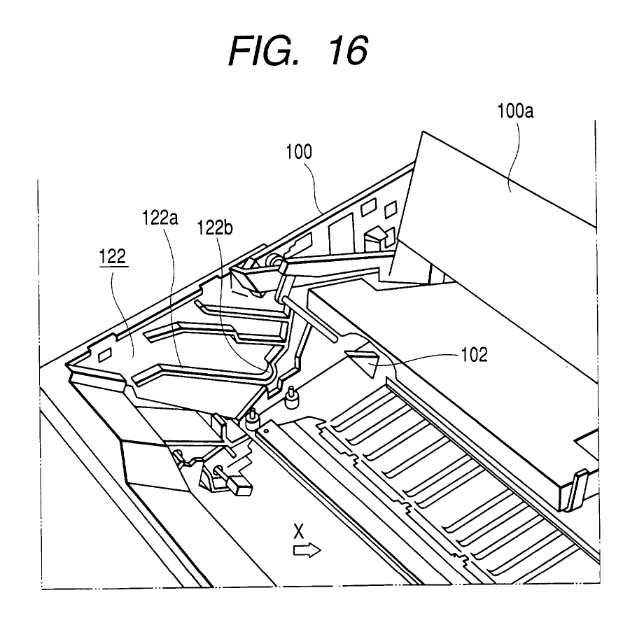

Next, attachment guide means at the time when the cartridge 2 is attached to or detached from a main body 100 on the basis of FIGS. 15 and 16. FIG. 15 is a perspective view showing a part of the main body 100 located in the right side of the developing unit 20 with viewing from an attachment direction (direction shown by an arrow X) in which the cartridge 2 is attached to the main body 100. Moreover, FIG. 16 is a perspective view showing a part of the main body 100 located in the left side of the developing unit 20 similarly.

In both external surfaces of the cleaning unit 10, a guide member of a cartridge side at the time when the cartridge 2 is attached to or detached from the main body 100 is defined by an exterior of the cylindrical portion 14a of the drum bearing 14, and an exterior of the cylindrical portion 15a of the drum shaft 15 that are shown in FIGS. 3 and 4.

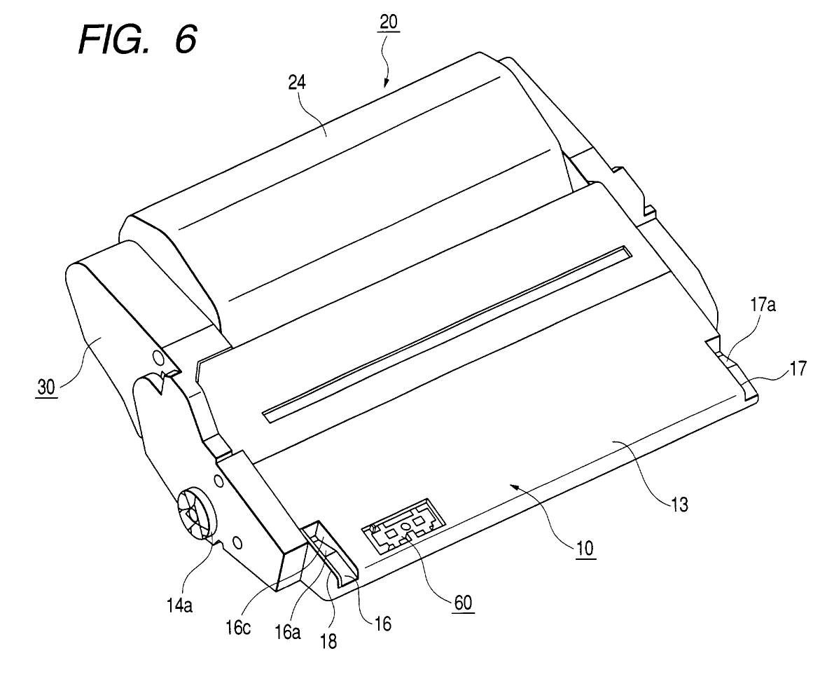

As shown in FIG. 3 or FIG. 6, on an upper surface of the drum frame body 13 constituting the cleaning unit 10 that is a main body of a process cartridge (main body of a unit), that is, a surface located in an upper side at the time when the cartridge 2 is attached to the main body 100, regulating and abutting portions 16a and 17a that are rotation regulating and abutting portions are provided in edges in the longitudinal direction orthogonal to the attachment direction of the process cartridge, respectively. Both regulating and abutting portions 16a and 17a are provided in each bottom of ends of grooves 16 and 17 that are attachment guide portions (groove portions) extending in the above-mentioned attachment direction. Then, they regulate the rotary position of the cartridge 2 when the cartridge 2 is attached to the main body 100.

That is, when the cartridge 2 is attached to the main body 100, as shown in FIGS. 15 and 16, the above-mentioned regulating and abutting portions 16a and 17a abut on the top points of fixed members 101 and 102 that are main body rotation-regulating members provided in the main body 100 of the image forming apparatus, respectively. Then, the rotary position of the cartridge 2 with centering the cylindrical portion 14a of the drum bearing 14 and the cylindrical portion 15a of the drum shaft 15 is regulated.

Next, a guide wall provided in the main body 100 will be described. When an opening and closing member 10a of the main body 100 shown in FIG. 1 is anti-clockwise rotated around a fulcrum, an upper portion of the main body 100 is opened. FIGS. 15 and 16 are partially perspective views showing attachment guide means to the main body 100 in both right and left ends of the cartridge 2. That is, as mentioned above, FIG. 15 shows a right side in the attachment direction of the cartridge 2 (X direction) when viewing both inner walls of the main body 100 from an opening generated by opening the opening and closing member 100a, and FIG. 16 shows a left side.

A guide member 121 (attachment means) is arranged in the right inner wall of the main body 100 as shown in FIG. 15, and a guide member 122 (attachment means) shown in FIG. 16 is formed in the left inner wall.

The guide members 121 and 122 comprise guide parts 121a and 122a that are obliquely installed so as to be declined toward the front in view of the direction shown by an arrow X that is the inserted direction (attachment direction) of the cartridge 2 respectively. Moreover, they connect to the guide members 121a and 122a respectively. Then, they comprise positioning grooves 121b and 122b that are semicircular attachment positions with which the cylindrical portion 14a that is a positioning member of the drum bearing 14 of the cartridge 2, and a cylindrical portion 15a that is a positioning member of the drum shaft 15 are just engaged. These positioning grooves 121b and 122b have cylindrical surrounding-walls. Then, centers of these positioning grooves 121b and 122b coincide with centers of the cylindrical portion 14a of the drum bearing 14 of the cartridge 2, and the cylindrical portion 15a of the drum shaft 15 respectively when the cartridge 2 is attached to the main body 100, and also coincide with a central axis that is a shaft line of the photosensitive body drum portion 11.

The width of guide members 121 and 122 has width at which the cylindrical portion 14a of the drum bearing 14 and the cylindrical portion 15a of the drum shaft 15 loosely engage in view of the attachment direction of the cartridge 2. Then, the cylindrical portion 14a of the drum bearing 14 of the cartridge 2 and the cylindrical portion 15a of the drum shaft 15 engage with the positioning grooves 121b and 122b of the guide members 121 and 122 of the main body 100 respectively when the cartridge 2 is attached to the main body 100. Moreover, regulating and abutting portions 16a and 17a in both sides of the drum frame body 13 of the cartridge 2 abut on points of the fixed members 101 and 102 of the main body 100.

(Structure of Laser Shutter)

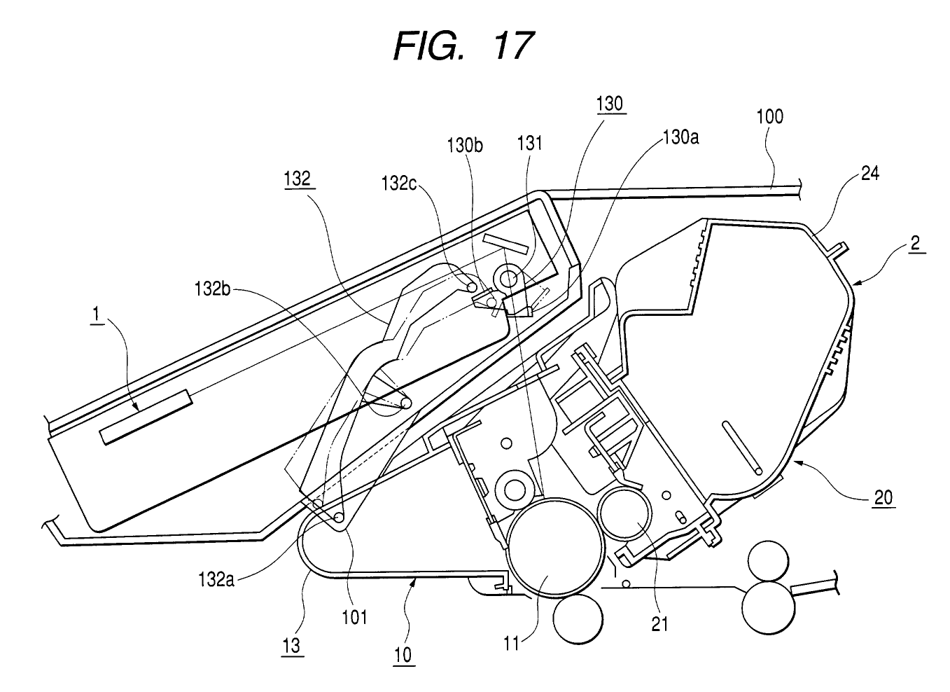

A shutter 130 that is an exposure optical shield member to shield a laser beam path is provided for a laser beam so as not to leak from the optical means 1 when the cartridge 2 is not attached to the main body 100 as shown in FIG. 17.

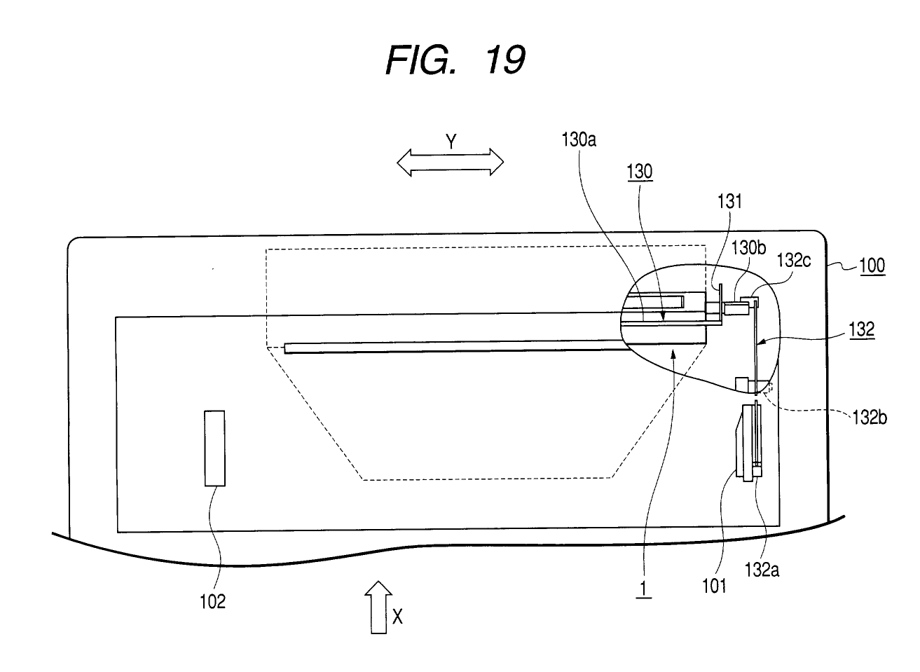

The shutter 130 is provided in the main body 100 of the image forming apparatus by a spindle (not shown) etc. so as to be rotatably around a shutter fulcrum 131. A shutter link 132 to rotate the shutter 130 is rotatably provided in the main body 100 by a bearing (not shown) etc. In addition, as shown in FIG. 19, this link 132 is arranged between the fixed member 101, to which the regulating and abutting portion 16a of the drum frame body 13 contacts, and a right sidewall of the main body 100 when the cartridge 2 is attached, in the Y direction orthogonal to the attachment direction (direction from the front to the interior in the figure) of the cartridge 2 shown by an arrow X. Moreover, an abutting portion 132a of the link 132 is arranged in an internal side of the fixed member 101 in the attachment direction of the cartridge 2.

Next, the operation of the shutter 130 and link 132 will be explained.

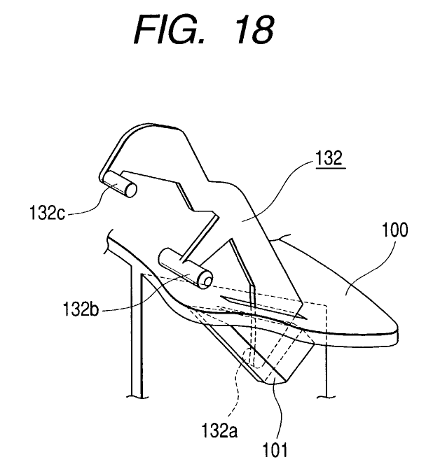

When the cartridge 2 is not attached to the main body 100, the shutter 130 is energized in the clockwise direction in FIG. 17 around the shutter fulcrum 131 by a spring and the like (not shown). Then, the shutter portion 130a shields the laser path in the position of contacting to the optical means 1. Then, a rib 18 that is a wall member of the groove 16 of the drum frame body 13 abuts on the abutting portion 132a of the link 132 as a driving member in the process where the cartridge 2 is attached to the main body 100 (refer to FIGS. 4 and 18). Thus, the link 132 rotates clockwise in FIG. 17 around a spindle 132b when the rib 18 of the drum frame body 13 of the cartridge 2 and the abutting portion 132a abut.

At this time, a boss 132c of the link 132 is pushed by contacting to the abutting portion 130b of the shutter 130. As a result, the shutter 130 rotates anti-clockwise around the shutter fulcrum 131, and evacuates the shutter portion 130a from the laser beam path.

In consequence, when the cartridge 2 is attached in a predetermined position in the main body 100, it is possible to surely radiate the laser beam to the photosensitive body drum 11 since the laser beam path is not shielded by the shutter portion 130a of the shutter 130.

(Structure of Memory Tag)

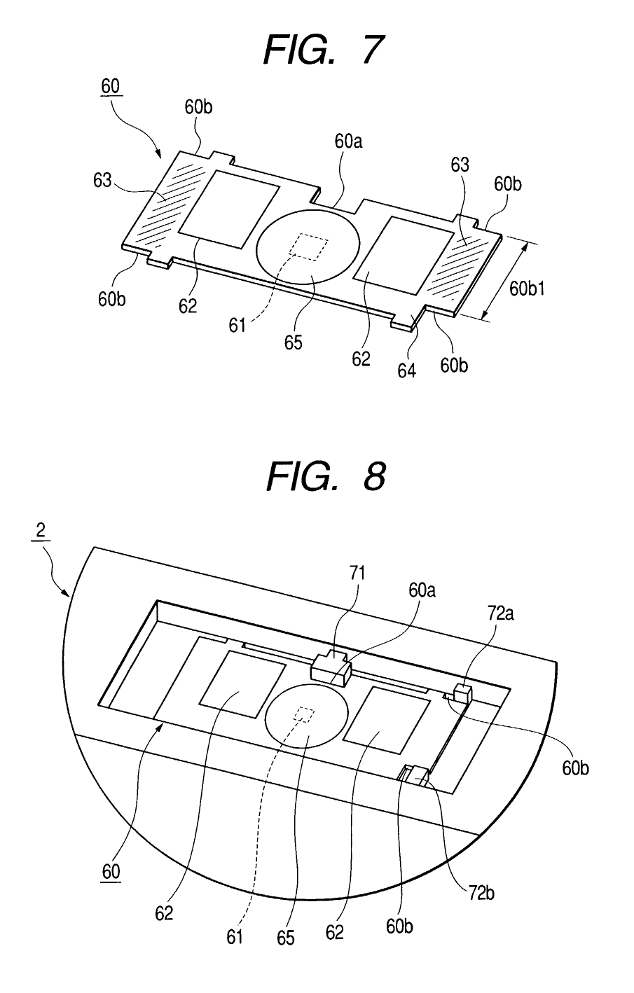

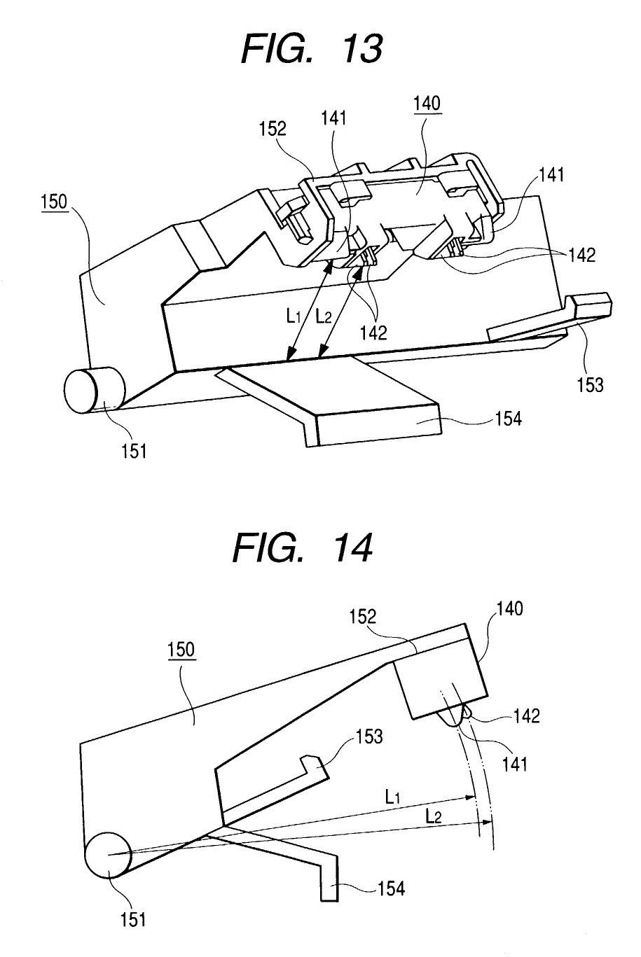

A memory tag 60 that is a main board is installed on a surface of the drum frame body 13 of the cartridge 2 as shown in FIG. 3 to FIG. 6. As shown in FIGS. 7 and 8, the memory tag 60 is a plate-like member where a memory element 61, a contact portion 62 that is a cartridge electrical contact portion, and an abutting portion 63 on which a bumping portion 141 of the connector 140 described later abuts are arranged on a board 64 (printed board) (refer to FIG. 13). Here, the contact portion 62 is made of conductive material, and is connected to the memory element 61 electrically.

The memory element 61 is arranged at a center, and is protected by a coating layer 65 (protective portion) with a resin. Moreover, contact portions 62 are coplanar with a coating layer 65 that protects the memory element 61, and, are arranged in both sides of the memory element 61. Moreover, in the vicinity of the contact portion 62, the abutting portion 63 on which the bumping portion 141 of the connector 140 shown in FIG. 13 abuts is arranged in parallel.

As shown in FIGS. 13 and 14, a metallic electrical contact 142 (main body electrical contact) generating contact pressure is provided in the connector 140. Then, when the bumping portion 141 abuts on the main body abutting portion 63 of the memory tag 60, the deflection of the electrical contact 142 becomes constant, and it is possible to make contact pressure to the contact portion 62 of the memory tag 60 be desired contact pressure, and hence, it is possible to stabilize continuity.

Moreover, dimensional precision in the height direction of the abutting portion 63 and contact portion 62 in the memory tag 60 is improved by making the abutting portion 63 of memory tag 60 be flush with the contact portion 62. As a result, it becomes possible to further stabilize the contact pressure of the electrical contact 142 of the connector 140.

In addition, the contact portion 62 is provided in both sides of a coating layer 65 (preventive portion) protecting the memory element 61 of the memory tag 60, and the abutting portion 63 is flatly arranged so as to be on the extension of both contact portions 62 and to be adjacent to the contact portion 62.

Since distance L1 to the bumping portion 141 of the connector 140 and distance L2 to the electrical contact 142 from a rotation axis 151 of a connector holder 150 that are shown in FIGS. 13 and 14 can be almost equated by providing the abutting portion 63 like this, the contact pressure of the electrical contact 142 is hardly influenced by dimensional dispersion of height of the bumping portion 141, and hence, can be stabilized.

In addition, since the abutting portion 63 of the memory tag 60 is arranged in parallel to the contact portion 62 and the distances to bumping portion 141 and electrical contact 142 of the connector 140 are almost equal, the pressure balance becomes uniform, and hence, it is possible to prevent a continuity failure due to contact pressure shortage of the contact portion 62 and the like.

Next, the installation structure of the memory tag 60 will be explained.

As shown in FIGS. 7 and 8, a concave groove portion 60a is provided in the longitudinal direction in a space with the contact portions 62 in one side edge of the memory tag 60. Then, the rib 71 that is a contact positioning portion orthogonal to the longitudinal direction of the memory tag 60 is formed in the cartridge 2, and positioning in a longitudinal direction is performed by engaging the groove portion 60a, which is a notched portion of the memory tag 60, with the rib 71. In addition, in a cross direction, positioning by width size 60b1 is performed by bumping a bumping portion 60b of the memory tag 60 to positioning portions 72a and 72b of the cartridge 2.

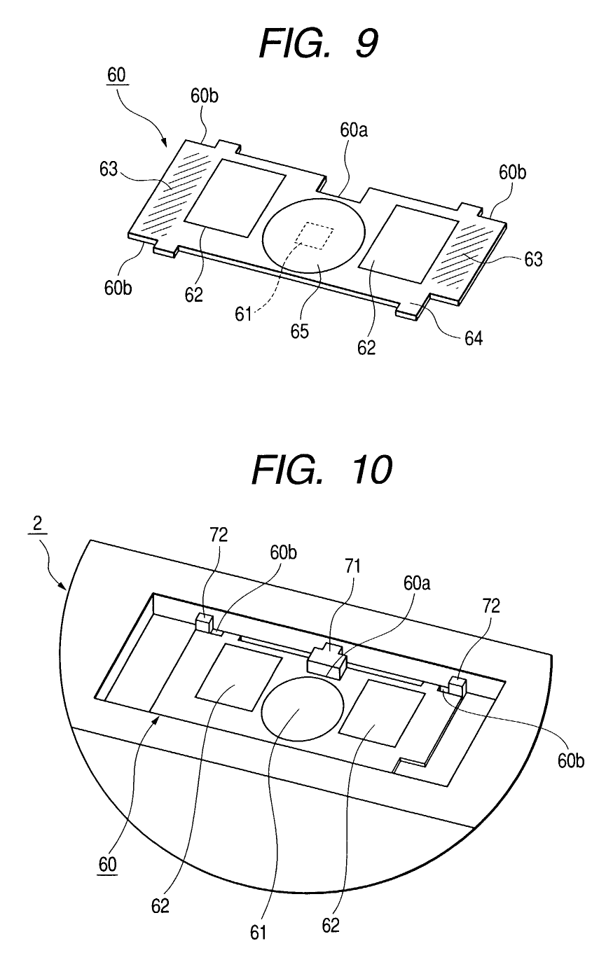

Moreover, positioning in the cross direction can be also performed by bumping the bumping portion 60b of the memory tag 60 to the positioning portion 72 of the cartridge 2 as shown in FIGS. 9 and 10. Positioning by bumping can achieve positioning in the cross direction even if the drawing direction of a molding die for a mounting portion of the memory tag 60 in the cartridge 2 is not parallel to a surface including the contact portion 62 of the memory tag 60.

Above positioning by bumping can achieve positioning in the cross direction even if the drawing direction of a molding die for a mounting portion of the memory tag 60 in the cartridge 2 is not parallel to a surface including the contact portion 62 of the memory tag 60. Therefore, it is possible to use the molding die for two or more products since the structure of the molding die does not control the positioning of the memory tag 60 in the longitudinal direction and the cross direction positioning, and hence, it is possible to plan cost reduction by an advantage of mass production.

In addition, if a positioning form is a hole (round hole or rectangular hole), the memory tag becomes large. However, the enlargement of the memory tag can be suppressed by making the form a concave notch as mentioned above.

Moreover, if the positioning form is a hole (round hole or rectangular hole), there is a possibility of a wrench when a positioning hole and a positioning boss engage. In particular, since a board at about 0.6 mm thick is used in this embodiment, the possibility of the wrench is large. However, if the form is made to be concave as mentioned above, there is not a possibility of the wrench, and assembly property further improves.

Next, the structure of the connector arranged in the main body 100 will be explained.

As shown in FIG. 13, in the connector 140, one or two metallic main body electrical contacts 142 generating contact pressure by elastic deformation are arranged per contact portion 62 of the memory tag 60. In sides of the electrical contact 142, the bumping portions 141 abutting on the abutting portion 63 of the memory tag 60 are provided in the vicinity of both sides in the longitudinal direction respectively. In the opposite side of a contact portion of the electrical contact 142 to the memory tag 60, a lead wire is connected to a control unit (not shown) of the main body 100.

The connector holder 150 comprises a rotation axis 151, a connector mounting portion 152, a longitudinal positioning lever 153 to position the connector 140, and an abutting rotation lever 154.

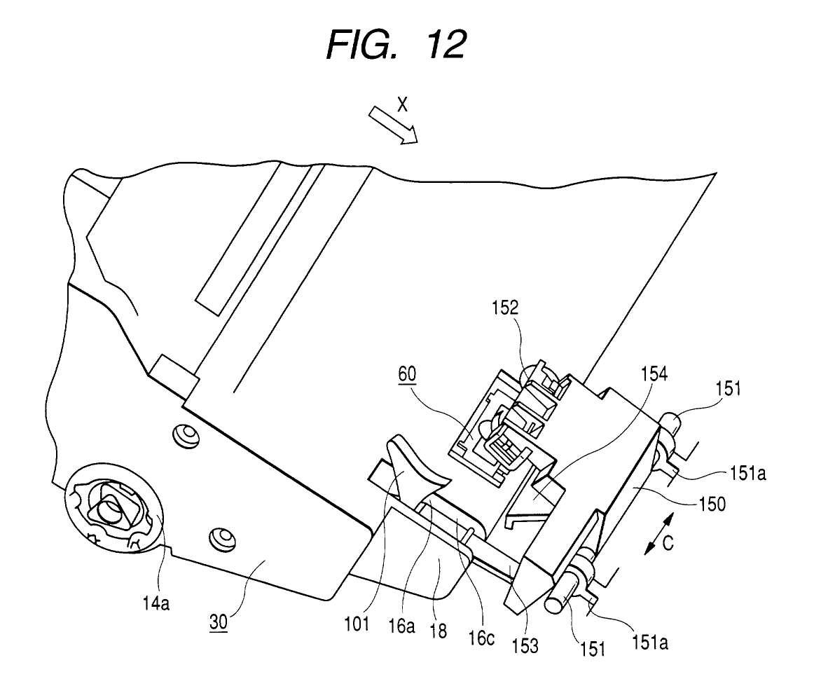

The connector 140 is fixed to the connector holder 150 with snap fitting or screws, etc. (not shown). In addition, the connector holder 150 rotates on the rotation axis 151 as previously stated, and as shown in FIG. 12, the rotation axis 151 is slidably supported in the longitudinal direction (direction shown by an arrow C) by a bearing 151a in the main body 100.

Next, the energized connection of the connector 140 and memory tag 60 will be explained according to the attachment operation of the cartridge 2 to the main body 100.

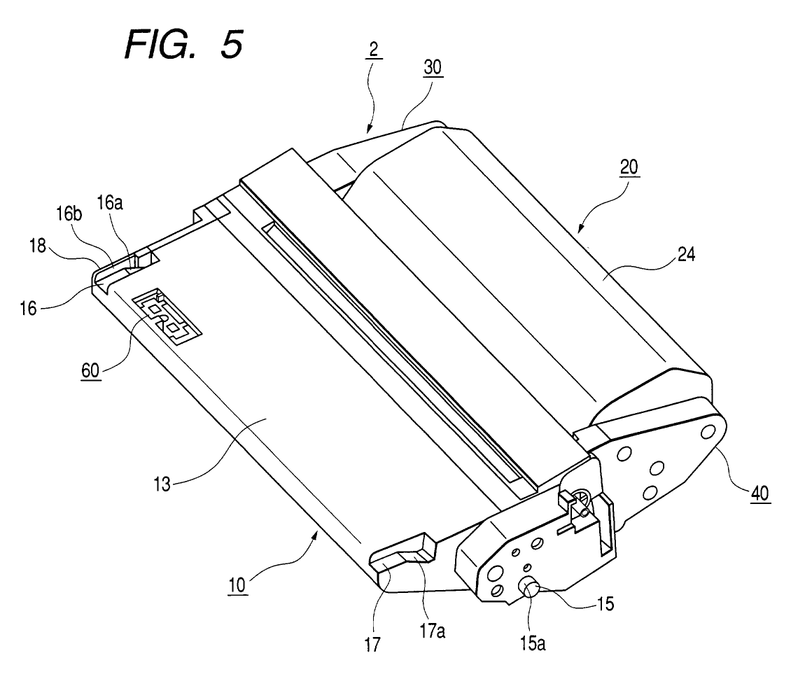

The regulating and abutting portion 16a in the right side of the cartridge 2 is provided in the groove 16 that is an attachment guide portion that has a wall member composed of the rib 18 that opens or closes the shutter 130 that is a laser beam shield member (exposure optical shield member) of the main body 100. In addition, the left regulating and abutting portion 17a is provided in the groove 17 that is an attachment guide portion whose outside is opened. As shown in FIG. 12, when the cartridge 2 is inserted into the main body 100 in the direction shown by an arrow X, the fixed member 101 in the main body 100 is led in between the cartridge attachment guide portions 16b and 16c (walls) of the groove 16 of the cartridge 2 on the way of insertion (refer to FIGS. 5 and 6), and hence, guide the cartridge 2 in the direction orthogonal to the attachment direction of cartridge 2. A longitudinal positioning lever 153 that is a main body support member positioning portion of the connector holder 150 that is a main body electrical contact supporting-member that is arranged movably in the longitudinal direction (above-mentioned orthogonal direction) enters in between end portions 16b and 16c of the point of the above-mentioned groove 16, when the cartridge 2 is further inserted. Then, the connector 140 is positioned in the longitudinal direction to the cartridge 2.

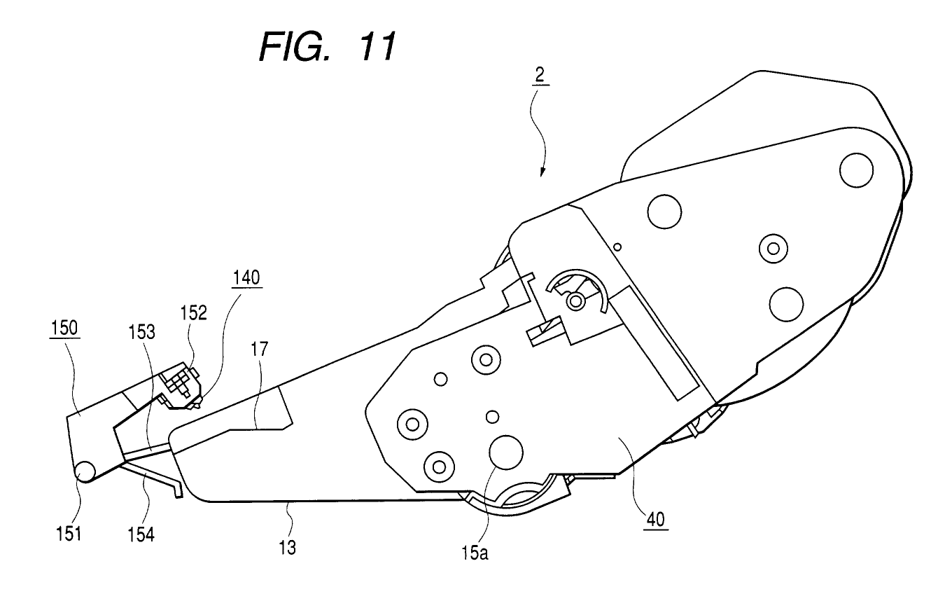

That is, the walls 16b and 16c of the groove 16 that is the above-mentioned attachment guide portion are cartridge attachment guide portions to guide the cartridge 2 in the direction orthogonal to the attachment direction. In addition, the walls 16b and 16c are cartridge supporting member positioning portions to perform the positioning of the connector 140 in the longitudinal direction that has the electrical contact 142 for the cartridge 2. Moreover, a bottom portion 16a of the groove 16 is a rotation-regulating and abutting portion that abuts on the fixed member 101, which is a main body rotation regulating-portion, and regulates the rotation of the cartridge 2. Therefore, the miniaturization of the cartridge 2 becomes possible. In addition, since the fixed member 101 that is a main body rotation regulating-portion is also a main body cartridge attachment guide portion that performs guidance in the direction orthogonal to the attachment direction of the cartridge 2, the miniaturization of the main body of the apparatus becomes also possible. Moreover, since the cartridge 2 abuts on the rotation lever 154 of the connector holder 150 when the cartridge 2 is inserted, the connector 140 rotates toward the memory tag 60 around the rotation axis 151 of the connector holder 150 (clockwise in FIG. 11).

Then, the cylindrical portion 14a of the drum bearing 14 of the cartridge 2 and the cylindrical portion 15a of the drum shaft 15 reach the positioning grooves 121b and 122b of the main body 100 (refer to FIGS. 15 and 16).

In the cartridge 2, when the central line that connects the center of the cylindrical portion 14a of the drum bearing 14 to the cylindrical portion 15a of the drum shaft 15 is kept horizontally in sides of the cleaning unit 10 and developing unit 20, weight is distributed so that the side of the developing unit 20 may have larger primary moment than the side of the cleaning unit 10. Hence, the cartridge 2 rotates clockwise on a line connecting the cylindrical portion 14a of the drum bearing 14 and the cylindrical portion 15a of the drum shaft 15, the regulating and abutting portions 16a and 17a of the cartridge 2 abut on points of the fixed members 101 and 102, and the insertion operation of the cartridge 2 is completed. In addition, the connector 140 abuts on the memory tag 60 at the same time.

As previously stated, by arranging the groove 16 near the memory tag 60 of the cartridge 2 and positioning the connector holder 150, where the connector 140 of the main body 100 is installed, by the walls 16b and 16c that are cartridge supporting-member positioning-portion of the groove 16, it is possible to make the contact portion 62 of the memory tag 60 and the connector 140 accurately abut and to make the state kept. Owing to this, it is possible to prevent the contact shift of the memory tag 60, and to plan the miniaturization of the connector unit.

Moreover, the above-mentioned groove 16 can reduce the width of the movable range of the connector unit in the longitudinal direction since the groove 16 also serves as the cartridge attachment guide portion in the direction orthogonal to the attachment direction when the cartridge 2 is attached to the main body 100, and hence it is possible to reduce the dimension of the main body 100 including the movable width of the connector unit. In addition, the lever 153 can be smoothly inserted into the groove 16 owing to the above-mentioned structure.

Moreover, it is possible to use a space more effectively by making the rib 18 for opening and closing the shutter 130 of the main body 100 be a wall member in an end constituting the above-mentioned groove 16.

Furthermore, as previously stated, since the above-mentioned groove 16 also serves as cartridge attachment guide portion in the direction orthogonal to the attachment direction at the time of attachment of the cartridge 2, it is possible to improve positional accuracy with the opening and closing mechanism of the shutter 130 in the main body 100, and also to contribute the miniaturization of a laser shutter mounting-portion of the main body 100.

(Embodiment 2)

In this embodiment, only items different from those in the above-mentioned first embodiment will be explained, and the explanation of the other structure similar to that of the first embodiment will be omitted.

Next, the structure of the connector arranged in the main body will be explained.

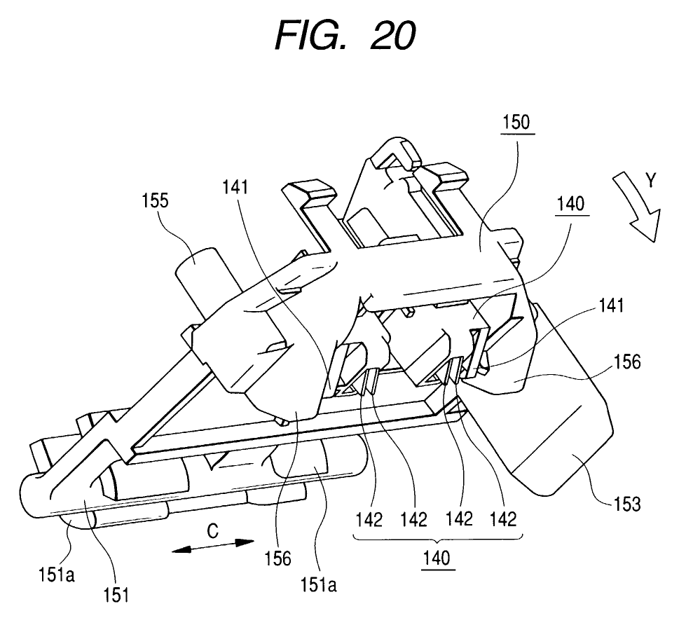

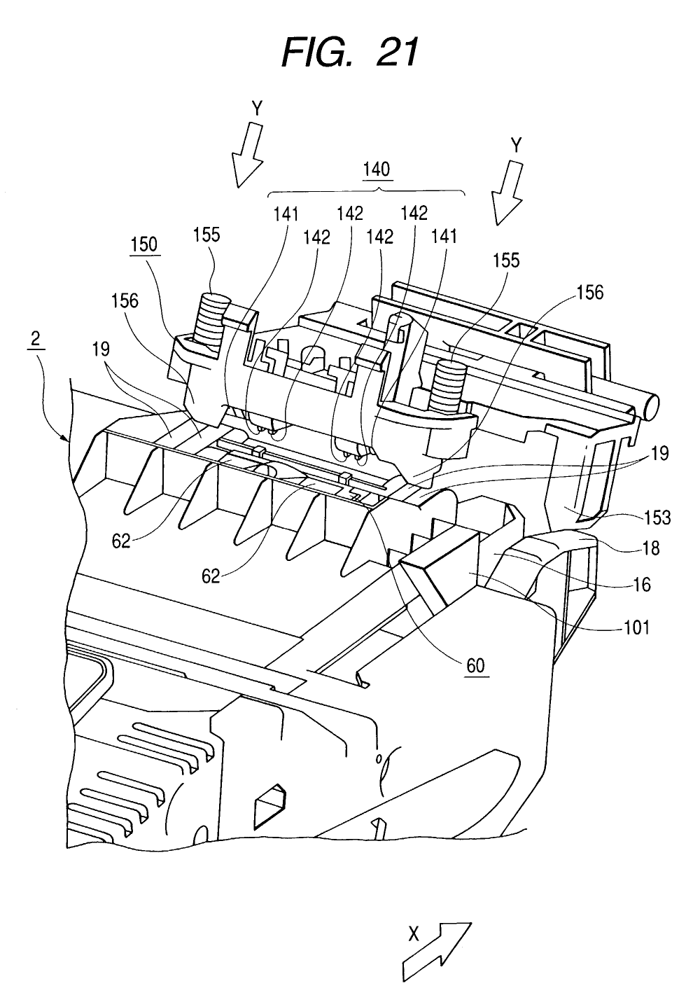

As shown in FIGS. 20 and 21, one or two electrical contacts 142 that are metallic main body electrical contacts generating contact pressure by elastic deformation are arranged in the connector 140 per contact portion 62 of the memory tag 60. Beside the electrical contact 142, the bumping portions 141 abutting on the abutting portion 63 (refer to FIGS. 7 and 9) of the memory tag 60 are provided in the vicinity of both sides in the longitudinal direction respectively. In the opposite side of a contact portion of the electrical contact 142 to the memory tag 60, a lead wire is connected to a control unit (not shown) of the main body 100.

The connector holder 150 comprises a rotation axis 151, a connector mounting portion 152, and a longitudinal positioning-lever 153 that it is a main body support member positioning-portion.

The connector 140 is fixed to the connector holder 150 with snap fitting or screws, etc. (not shown) In addition, the connector holder 150 rotates on the rotation axis 151 as previously stated, and as shown in FIG. 12, the rotation axis 151 is slidably supported in the longitudinal direction (direction shown by an arrow C (, that is, direction orthogonal to the attachment direction of the cartridge 2) by a bearing 151a in the main body 100. Then, the connector holder 150 is energized in the direction shown by an arrow Y by a spring 155.

Next, the connection of the connector 140 and memory tag 60 will be explained according to the attachment operation of the cartridge 2 to the main body 100.

In addition, similarly to the first embodiment, the regulating and abutting portion 16a (not shown) in the right side of the cartridge 2 is provided in the groove 16 that is an attachment guide portion that has a wall member composed of the rib 18 that opens or closes the shutter 130 that is a laser beam shield member (exposure optical shield member) of the main body 100. In addition, the left regulating and abutting portion 17a is provided in the groove 17 that is an attachment guide portion whose outside is opened (not shown). As shown in FIGS. 21, 25, and 26, when the cartridge 2 is inserted into the main body 100 in the direction shown by an arrow X, the cartridge attachment guide portions 16b and 16c (not shown) of the groove 16 of the cartridge 2 sandwich the fixed member 101 in the main body 100 on the way of insertion (refer to FIGS. 5 and 6), and hence, guide the cartridge 2 in the direction orthogonal to the attachment direction of cartridge 2. A longitudinal positioning lever 153 that is a main body support member positioning portion of the connector holder 150 that is a main body electrical contact supporting-member that is arranged movably in the longitudinal direction (above-mentioned orthogonal direction) enters between end portions 16b and 16c of the point of the above-mentioned groove 16, when the cartridge 2 is further inserted, and positioning of the connector 140 in the longitudinal direction to the cartridge 2 is performed.

That is, the walls 16b and 16c of the groove 16 that is the above-mentioned attachment guide portion are cartridge attachment guide portions to guide the cartridge 2 in the direction orthogonal to the attachment direction. In addition, the walls 16b and 16c are cartridge supporting member positioning portions to perform the positioning of the connector 140 in the longitudinal direction that has the electrical contact 142 for the cartridge 2. Moreover, a bottom portion 16a of the groove 16 is a rotation regulating and abutting portion that abuts on the fixed member 101, which is a main body rotation regulating-portion, and regulates the rotation of the cartridge 2. Therefore, the miniaturization of the cartridge 2 becomes possible. In addition, since the fixed member 101 that is a main body rotation regulating-portion is also a main body cartridge attachment guide portion that performs guidance in the direction orthogonal to the attachment direction of the cartridge 2, the miniaturization of the main body of the apparatus becomes also possible.

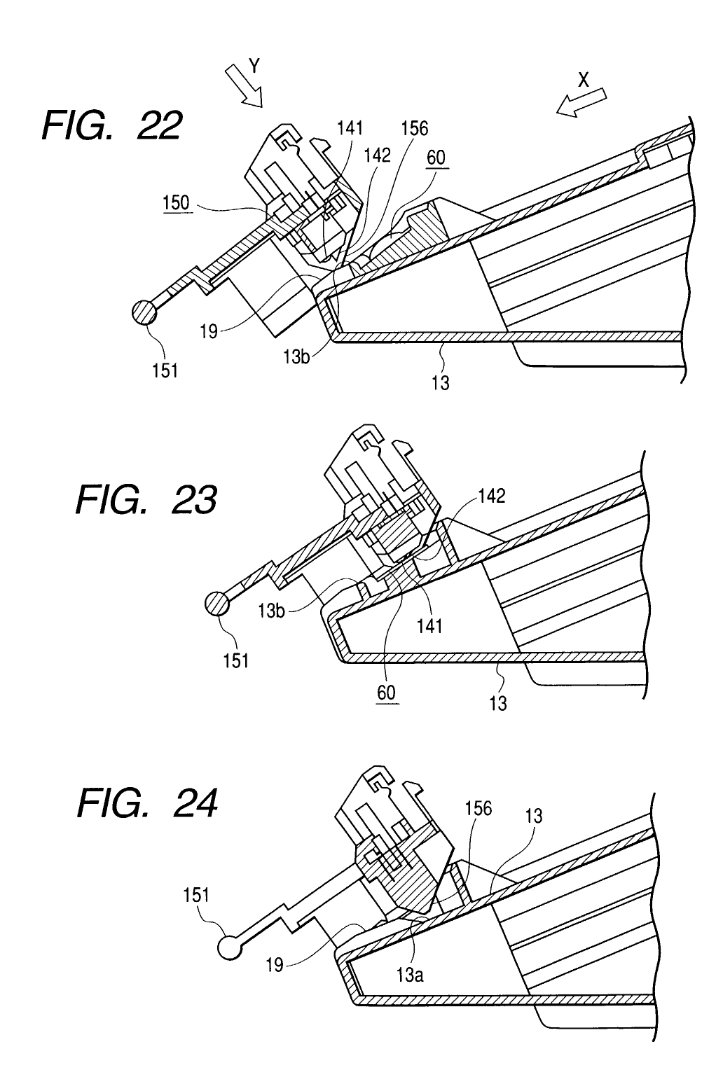

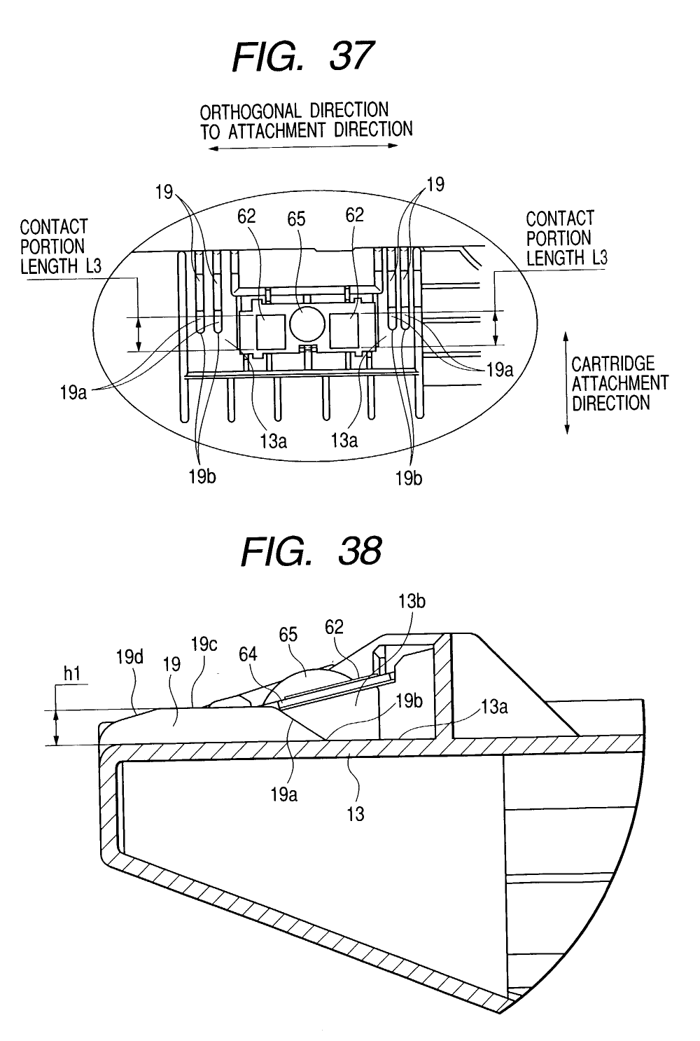

Moreover, as shown in FIG. 21, in the drum frame body 13 of the cartridge 2, a connector holder guide 19 that is a cartridge abutting portion is provided in the vicinity of both ends of a mounting portion of the memory tag 60. Then, the connector holder 150 is energized in the direction shown by an arrow Y by a spring 155 as previously stated. Then, as shown in FIG. 22, when the cartridge 2 is further inserted, a guide rib 156 that is a main body abutting portion provided in the connector holder 150 abuts on the connector holder guide 19 and slides. At this time, the electrical contact 142 and abutting portion 63 of the connector 140 do not contact to the memory tag 60 and the drum frame body 13 that is a frame body supporting the memory tag 60. The connector holder guide 19 is set at height hl by which the above-mentioned structure can be obtained. In addition, as shown in FIGS. 37 and 38, in the direction orthogonal to the cartridge attachment direction, an inclined plane 19a is provided in the upstream side of the connector holder guide 19, which is provided in parallel to the memory tag 60, in the cartridge attachment direction. Then, the structure is that an edge 19b in the upstream of the inclined plane 19a in the cartridge attachment direction is located within the length L3 of the contact portion 62 in the cartridge attachment direction as shown in FIG. 37. The guide rib 156 is lowered along the inclined plane 19a owing to the above-mentioned structure. Then, the connector holder 150 is guided so that the electrical contact 142 may abut on the contact portion 62 of the memory tag 60 immediately before being attached in a predetermined attachment position of the main body 100. It is possible to come in contact smoothly without the impact being given to the electrical contact 142 when the electrical contact 142 and contact portion 62 come in contact owing to the above-mentioned structure. As shown in FIGS. 23 and 24, the bumping portion 141 abuts on the abutting portion 63 of the memory tag 60, and the guide rib 156 comes to a position that corresponds to the concave portion 13a that is a surface of the frame body to be apart from the frame body 13 (FIG. 24 is a sectional view showing the positional relation between the connector holder guide 19 and guide rib 156 in the state that the connector 140 is abutting on the memory tag 40 (FIG. 23)). In addition, the memory tag 60 is provided in the mounting-portion 13b that projects from an upper side of the cartridge frame body 13. Then, when the process cartridge is attached in the above-mentioned apparatus position, the height of the above-mentioned mounting-portion 13b is set at such height that a space is formed between the guide rib 156 and a surface 13a of the cartridge frame body as shown in FIG. 24.

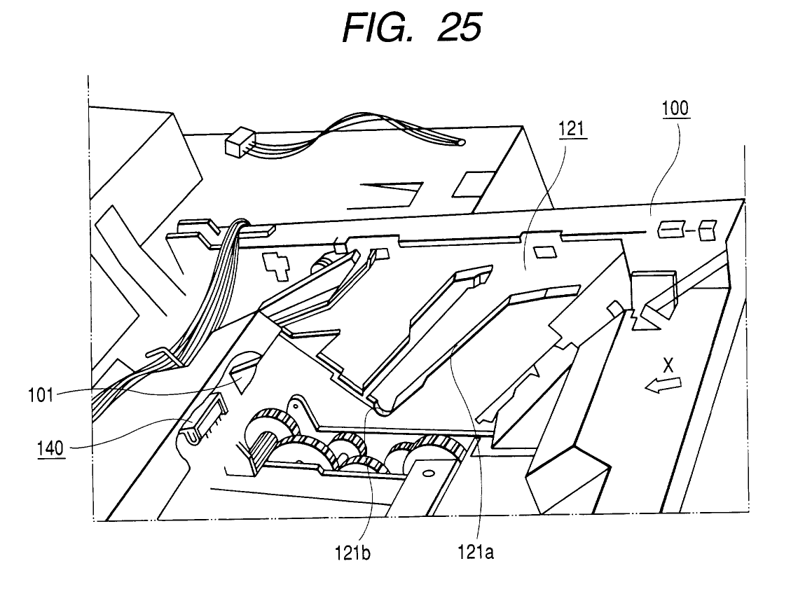

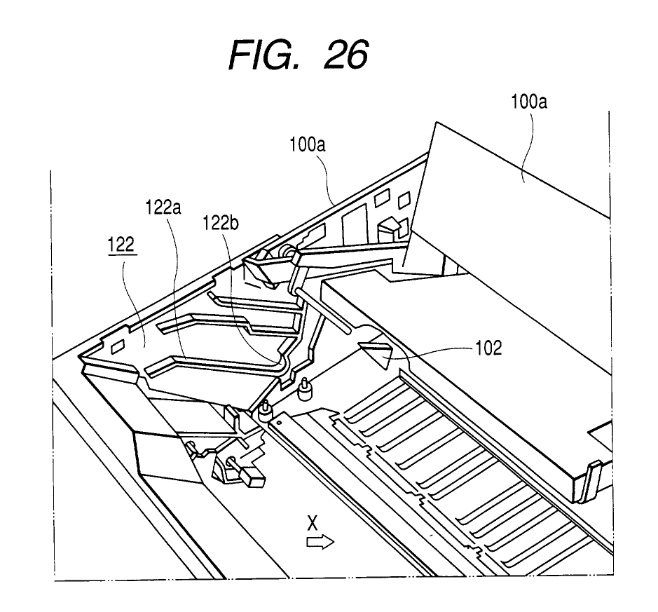

Then, the cylindrical portion 14a of the drum bearing 14, which is a positioning member of the cartridge 2, and the cylindrical portion 15a of the drum shaft 15 reach the positioning grooves 121b and 122b of the main body 100 (refer to FIGS. 25 and 26).

In the cartridge 2, as for the relation between primary moments of sides of the cleaning unit 10 and developing unit 20 around a central line that connects the center of the cylindrical portion 14a of the drum bearing 14 to the cylindrical portion 15a of the drum shaft 15, weight is distributed so that the side of the developing unit 20 may have larger primary moment than the side of the cleaning unit 10. Hence, the cartridge 2 rotates clockwise on a line connecting the cylindrical portion 14a of the drum bearing 14 and the cylindrical portion 15a of the drum shaft 15, the regulating and abutting portions 16a and 17a of the cartridge 2 abut on points of the fixed members 101 and 102, and the insertion operation of the cartridge 2 is completed.

Owing to the above-mentioned structure, since the electrical contact 142 of the connector 140 of the main body 100 comes in contact surely and stably with contact portion by preventing the electrical contact 142 from coming in abut on a portion excluding the memory tag 60 (for example, the rib 13b, etc. provided in an end of the memory tag 60 in the cartridge 2 insertion direction) because of the dispersion of posture of the cartridge 2 during attachment to the main body 100, reliable continuity can be secured.

Then, since the deflection of the electrical contact 142 becomes constant and it is possible to make contact pressure to the contact portion 62 of the memory tag 60 be desired contact pressure, it is possible to stabilize continuity.

In addition, similarly to the first embodiment, as previously stated, by arranging the groove 16 near the memory tag 60 of the cartridge 2 and positioning the connector holder 150, where the connector 140 of the main body 100 is installed, by the walls 16b and 16c that are cartridge supporting-member positioning-portion of the groove 16, it is possible to make the contact portion 62 of the memory tag 60 and the connector 140 accurately abut and to make the state kept. Owing to this, it is possible to prevent the contact shift of the memory tag 60, and to plan the miniaturization of the connector unit.

Moreover, the above-mentioned groove 16 can reduce the movable width of the connector unit in the longitudinal direction since the groove 16 also serves as the cartridge attachment guide portion in the direction orthogonal to the attachment direction when the cartridge 2 is attached to the main body 100, and hence it is possible to reduce the dimension of the main body 100 including the movable width of the connector unit. In addition, the lever 153 can be smoothly inserted into the groove 16 owing to the above-mentioned structure.

In addition, it is possible to use a space more effectively by making the rib 18 for opening and closing the shutter 130 of the main body 100 be a side wall in an end constituting the above-mentioned groove 16. Moreover, as previously stated, since the above-mentioned groove 16 also serves as cartridge attachment guide portion in the direction orthogonal to the attachment direction at the time of attachment of the cartridge 2, it is possible to improve positional accuracy with the opening and closing mechanism of the shutter 130 in the main body 100, and also to contribute the miniaturization of a laser shutter mounting-portion of the main body 100.

(Embodiment 3)

In this embodiment, only items different from those in the above-mentioned first and second embodiments will be explained, and the explanation of the other structure similar to that of the first embodiment will be omitted.

Next, the structure of a connector arranged in the main body 100 will be explained.

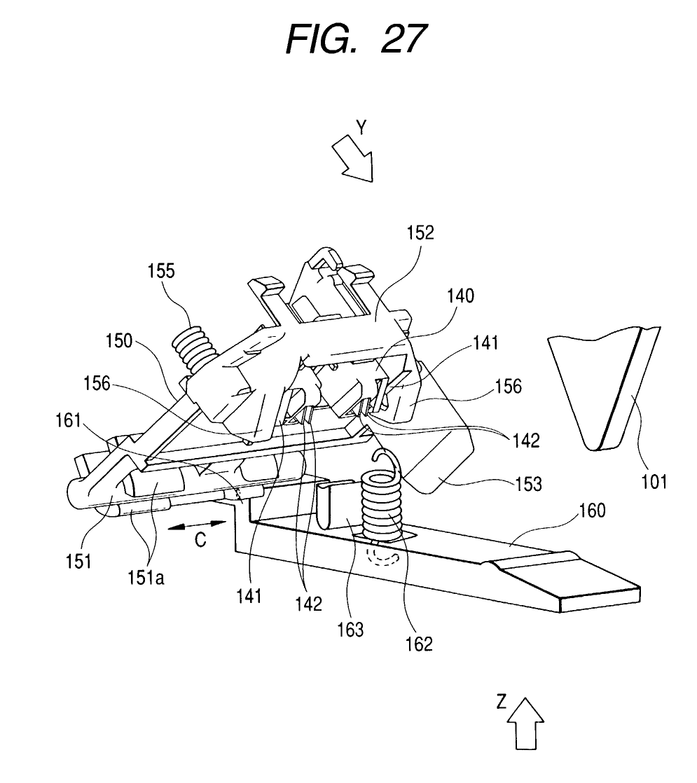

As shown in FIG. 27, one or two electrical contacts 142 that are metallic main body electrical contacts generating contact pressure by elastic deformation are arranged in the connector 140 per contact portion 62 of the memory tag 60. In sides of the electrical contact 142, the bumping portions 141 abutting on the abutting portion 63 (refer to FIGS. 7 and 9) of the memory tag 60 are provided in the vicinity of both sides in the longitudinal direction respectively. In the opposite side of a contact portion of the electrical contact 142 to the memory tag 60, a lead wire is connected to a control unit (not shown) of the main body 100.

The connector holder 150 comprises a rotation axis 151, a connector mounting portion 152, and a longitudinal positioning-lever 153 that it is a main body support member positioning-portion.

The connector 140 is fixed to the connector holder 150 with snap fitting or screws, etc. (not shown). In addition, as shown in FIG. 27, the connector holder 150 rotates around the rotation axis 151 as previously stated, and as shown in FIG. 12, the rotation axis 151 is slidably supported in the longitudinal direction (direction shown by an arrow C (, that is, direction orthogonal to the attachment direction of the cartridge 2) by a bearing 151a in the main body 100. Then, the connector holder 150 is energized in the direction shown by an arrow Y by a spring 155.

Next, the connection of the connector 140 and memory tag 60 will be explained according to the attachment operation of the cartridge 2 to the main body 100.

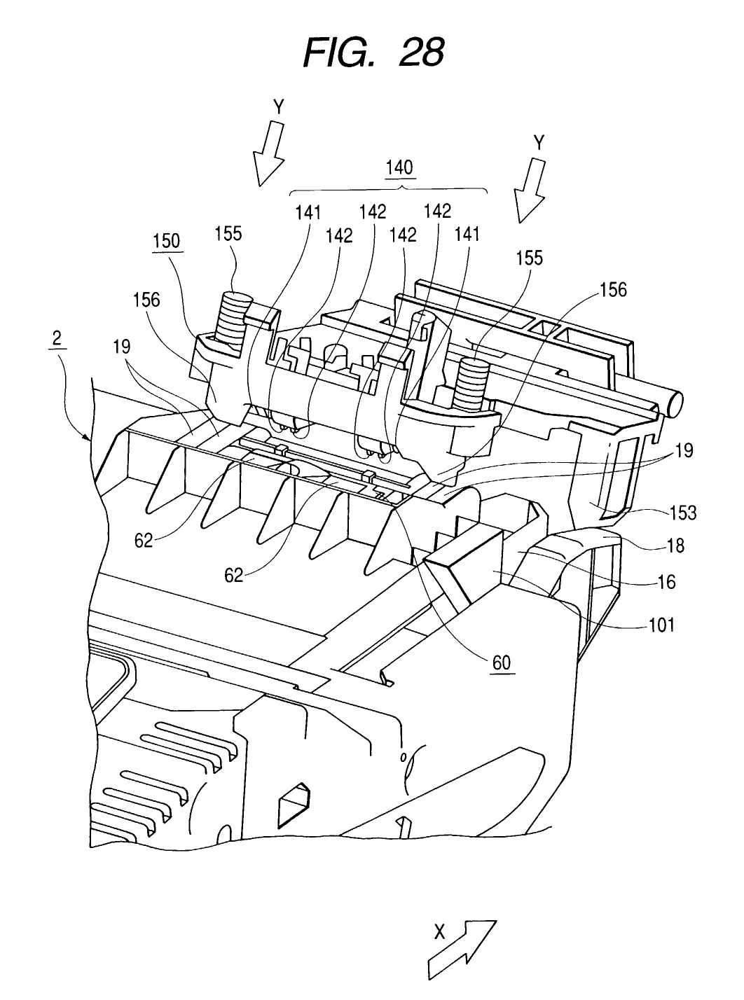

In addition, similarly to the first and second embodiments, the regulating and abutting portion 16a (not shown) in the right side of the cartridge 2 is provided in the groove 16 that is an attachment guide portion that has a wall member composed of the rib 18 that opens or closes the shutter 130 that is a laser beam shield member (exposure optical shield member) of the main body 100 (not shown). In addition, the left regulating and abutting portion 17a is provided in the groove 17 that is an attachment guide portion whose outside is opened (not shown). As shown in FIGS. 28, 32, and 33, when the cartridge 2 is inserted into the main body 100 in the direction shown by an arrow X, the cartridge attachment guide portions 16b and 16c of the groove 16 of the cartridge 2 sandwich the fixed member 101 in the main body 100 on the way of insertion (refer to FIGS. 5 and 6), and hence, guide the cartridge 2 in the direction orthogonal to the attachment direction of cartridge 2. A longitudinal positioning lever 153 that is a main body support member positioning portion of the connector holder 150 that is a main body electrical contact supporting-member that is arranged movably in the longitudinal direction (above-mentioned orthogonal direction) enters between end portions 16b and 16c of the point of the above-mentioned groove 16, when the cartridge 2 is further inserted, and positioning of the connector 140 in the longitudinal direction to the cartridge 2 is performed.

That is, the walls 16b and 16c of the groove 16 that is the above-mentioned attachment guide portion are cartridge attachment guide portions to guide the cartridge 2 in the direction orthogonal to the attachment direction. In addition, the walls 16b and 16c are cartridge supporting member positioning portions to perform the positioning of the connector 140 in the longitudinal direction that has the electrical contact 142 for the cartridge 2. Moreover, a bottom portion 16a of the groove 16 is a rotation regulating and abutting portion that abuts on the fixed member 101, which is a main body rotation regulating-portion, and regulates the rotation of the cartridge 2. Therefore, the miniaturization of the cartridge 2 becomes possible. In addition, since the fixed member 101 that is a main body rotation regulating-portion is also a main body cartridge attachment guide portion that performs guidance in the direction orthogonal to the attachment direction of the cartridge 2, the miniaturization of the main body of the apparatus becomes also possible.

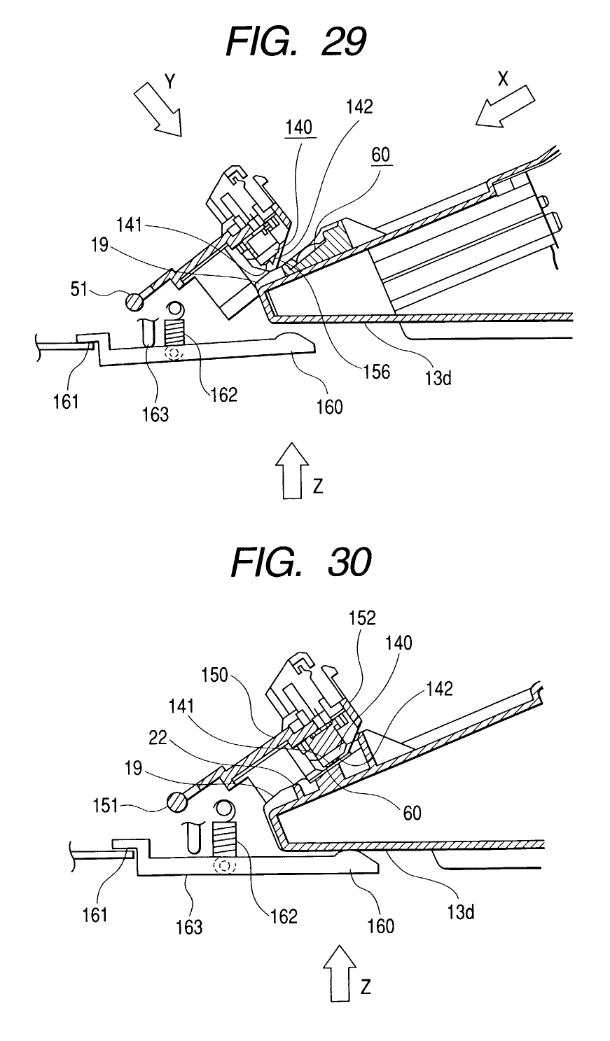

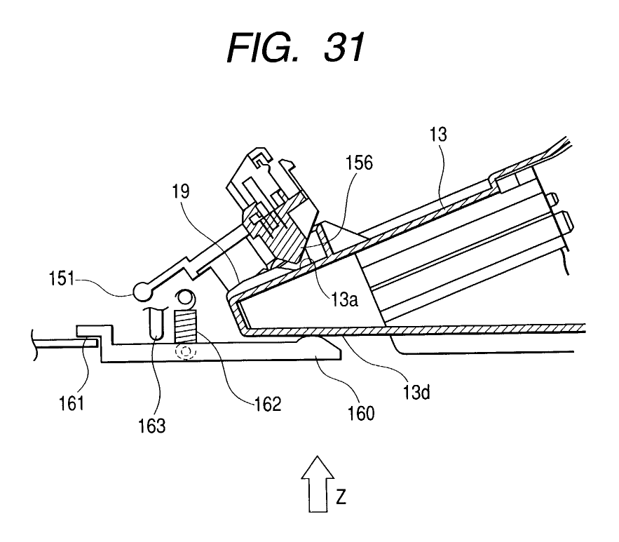

Moreover, as shown in FIG. 28, in the cartridge 2, a plurality of rib-like connector holder guides 19 that are in parallel to the inserted direction of the cartridge 2 into the main body 100 is provided in the vicinity of both ends of a mounting portion of the memory tag 60. Then, the connector holder 150 is energized in the direction shown by an arrow Y by a spring 155 as previously stated. Then, as shown in FIG. 29, when the cartridge 2 is further inserted, a guide rib 156 that is a main body abutting portion provided in the connector holder 150 abuts on a portion 19c of the connector holder guide 19 and slides thereafter (According to circumstances, after abutting on the portion 19d of the connector holder guide 19 first, the guide rib 15 slides to the portion 19c). At this time, the electrical contact 142 and abutting portion 63 of the connector 140 (refer to FIG. 7) do not abut on the memory tag 60 and the drum frame body 13 supporting the memory tag 60. The connector holder guide 19 is set at height hi by which the above-mentioned structure can be obtained. In addition, as shown in FIGS. 37 and 38, in the direction orthogonal to the cartridge attachment direction, an inclined plane 19a is provided in the upstream side of the connector holder guide 19 toward the direction of the cartridge attachment, which is provided in parallel to the memory tag 60, in the cartridge attachment direction. Then, the structure is that an edge 19b in the upstream of the inclined plane 19a in the cartridge attachment direction is located within the length L3 of the contact portion 62 in the cartridge attachment direction as shown in FIG. 37. The guide rib 156 is lowered along the inclined plane 19a owing to the above-mentioned structure. Then, the connector holder 150 is guided so that the electrical contact 142 may abut on the contact portion 62 of the memory tag 60 immediately before being attached in a predetermined attachment position of the main body 100. It is possible to come in contact smoothly without the impact being given to the electrical contact 142 when the electrical contact 142 and contact portion 62 come in contact owing to the above-mentioned structure. Then, as shown in FIGS. 30 and 31, when the bumping portion 141 abuts on the abutting portion 63 (refer to FIG. 7) of the memory tag 60, the guide rib 156 comes to the position corresponds to the surface 13a of the frame body to be apart from the frame body 13. (FIG. 31 is a sectional view showing the positional relation between the connector holder guide 19 and guide rib 156 in such a state (FIG. 30) that the connector 140 abuts on the memory tag 40.) In addition, the memory tag 60 is provided in the mounting-portion 13b that projects from an upper side of the cartridge frame body 13. Then, when the process cartridge is attached in the above-mentioned apparatus position, the height of the above-mentioned mounting-portion 13b is set at such height that a space is formed between the guide rib 156 and concave portion 13a as also shown in FIG. 24.

In addition, in the main body 100, a pushing member 160 is arranged at the position corresponding to a lower portion of the front of the cartridge 2 in the attachment direction as shown in FIGS. 27, 29, 30, and 31.

This pushing member 160 is rotatably supported by a frame member (not shown) of the main body 100 at a fulcrum 161, and is energized by a tension spring 162 in the direction shown by an arrow Z. In addition, the pushing member 160 keeps a position in which it abuts on a stopper 163 until abutting on the pushed portion 13d provided on a lower surface of the frame body 13 of the cartridge. The pushed portion 13d is arranged at a position where the pushing member can abut in condition that the cartridge 2 is inserted into the main body 100.

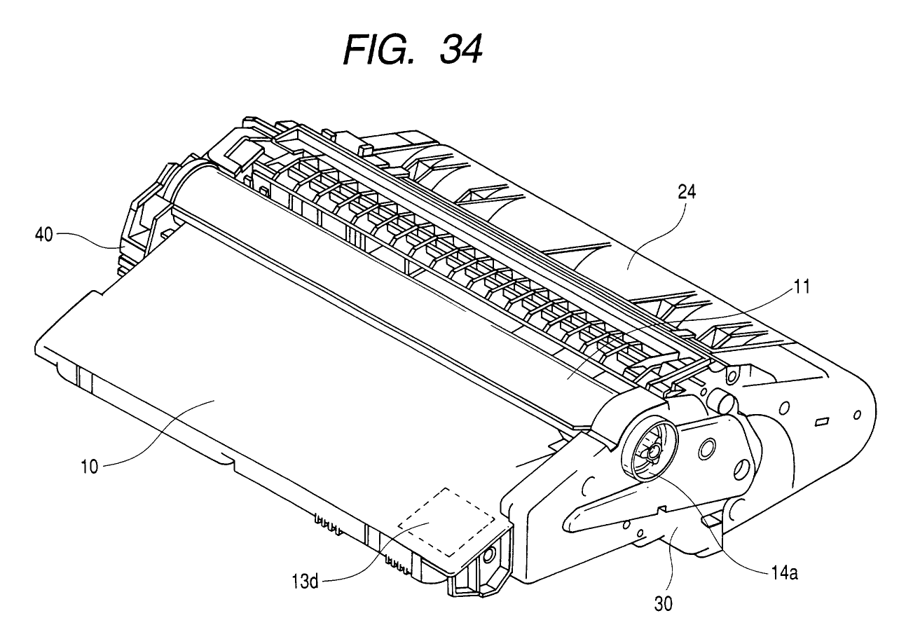

Furthermore, the longitudinal arrangement of the pushed portion 13d of the cartridge of this embodiment is between the memory tag 60 and regulating and abutting portion 16a of the cartridge as shown in FIG. 34.

Owing to this pushing member 160, the pushing member 160 abuts on the pushed portion 13d of the cartridge 2 almost at the same time as the operation that the above-mentioned cartridge 2 is attached in a predetermined position of the main body 100.

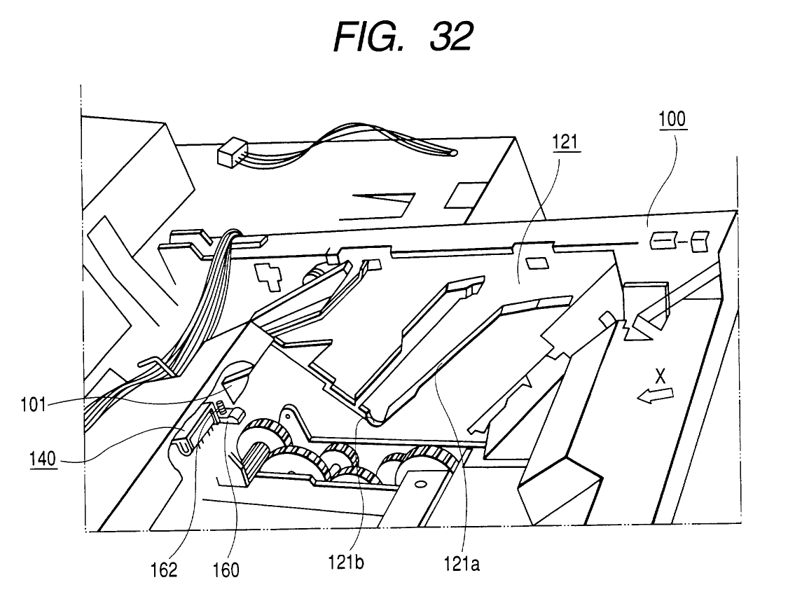

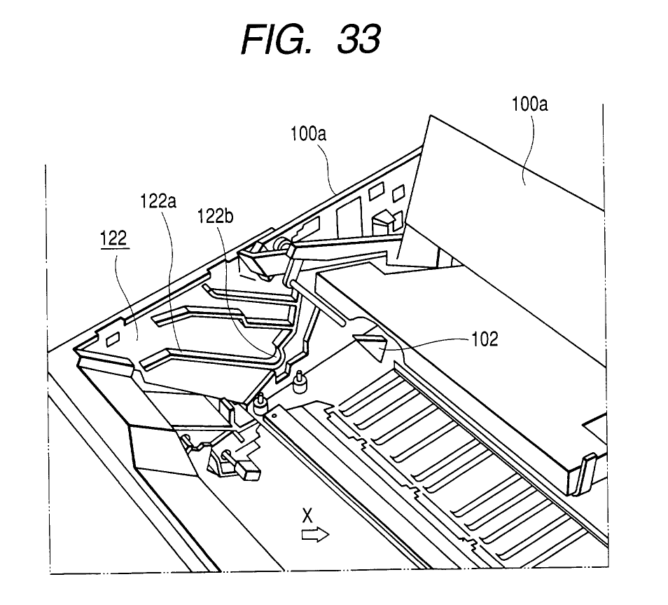

Then, the cylindrical portion 14a (refer to FIG. 6) of the drum bearing 14 of the cartridge 2 and the cylindrical portion 15a (refer to FIG. 5) of the drum shaft 15 reach the positioning grooves 121b and 122b of the main body 100 (refer to FIGS. 32 and 33).

In addition, as for the relation between primary moments of sides of the cleaning unit 10 and developing unit 20 around a central line (hereafter, this is called a drum axial line) that connects the center of the cylindrical portion 14a of the drum bearing 14 to the cylindrical portion 15a of the drum shaft 15, weight is distributed so that the side of the developing unit 20 may have larger moment rotating downward than the side of the cleaning unit 10.

In addition, moment by a forcer of the connector in the direction shown by an arrow Y is generated around the drum shaft line in the memory tag 60. However, moment in the direction opposite to the moment by the above-mentioned connector 140 is generated since the pushed portion 13d of the cartridge 2 is pushed in the direction shown by an arrow Z by the pushing member 160.

In addition, in order that the regulating and abutting portions 16a and 17a of the below-mentioned cartridges 2 may surely abut on points of the fixed members 101 and 102, the desirable relation between the moments around the drum shaft line of the cartridge 2 is as follows:

Moment by connector 140 <Moment by pushing member 160

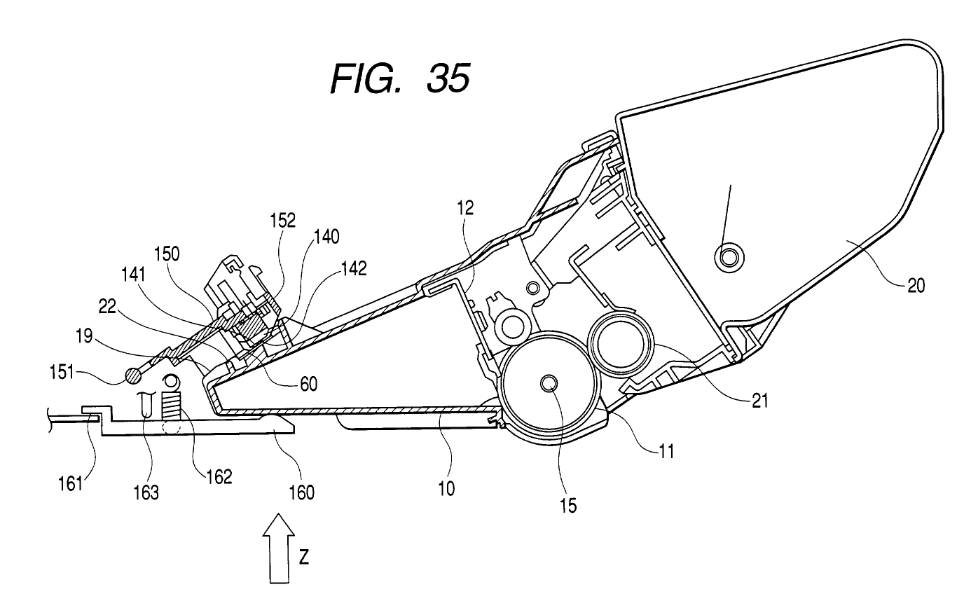

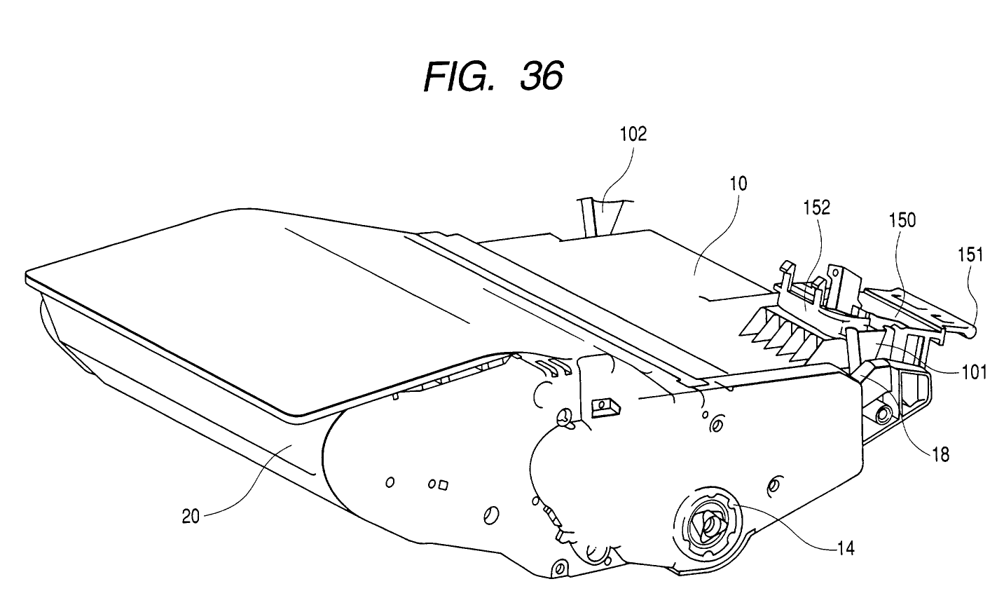

Furthermore, as shown in FIG. 35, the cartridge 2 rotates clockwise on the drum axial line (in FIG. 35, around the photosensitive body drum 11), the regulating and abutting portions 16a and 17a of the cartridge 2 abut on points of the fixed members 101 and 102 shown in FIG. 36, and the insertion operation of the cartridge 2 is completed.

In addition, since the photosensitive body drum 11 rotates clockwise when the photosensitive body drum 11 is given rotation drive from driving means (not shown) of the main body 100, the cartridge 2 also rotates clockwise. Therefore, also when being given the rotation drive from the main body 100, the regulating and abutting portions 16a and 17a (not shown) of the cartridge 2 always abut on the points of the fixed members 101 and 102 of the main body 100.

In addition, although the pushed portion 13d of the cartridge is arranged in a lower side (paper-passing side) in the above-mentioned structure, the section arrangement of the pushed portion 13d of the cartridge and the main body pushing portion 160 may have such relation that the moment to resist a force in the direction shown by an arrow Y with respect to the drum shaft line of the cartridge 2 is obtained.

Furthermore, also in the longitudinal arrangement, a desirable position is the same position as the connector 140, but so long as it is its neighborhood, a similar effect can be obtained.

Since the regulating and abutting portions 16a and 17a of the cartridge 2 surely abut on the points of the fixed members 101 and 102 owing to the above-mentioned structure, positioning of cartridge 2 with the main body can be accurately performed.

In addition, since the deflection of the electrical contact 142 becomes constant because the positioning of the cartridge 2 and connector 140 is accurately performed, it is possible to make contact pressure to the contact portion 62 of the memory tag 60 be desired contact pressure, and hence, it is possible to stabilize continuity.

Furthermore, as mentioned above, in the cartridge 2, as for the relation between primary moments of sides of the cleaning unit 10 and developing unit 20 around the drum axial line, weight is distributed so that the side of the developing unit 20 may have larger primary moment than the side of the cleaning unit 10. However, when a large amount of toner in the developing unit 20 of the cartridge is consumed and the waste toner is built up in the cleaning unit 10, the moment where the side of the developing unit 20 rotates downward (clockwise direction) becomes small, and the moment where the side of the cleaning unit 10 rotated downward (anti-clockwise direction) becomes large.

Furthermore, also when the cartridge 2 is not given the rotation drive from the main body 100, even a force in the direction where the regulating and abutting portions 16a and 17a (not shown) of the cartridge 2 abut on the points of the fixed members 101 and 102 of the main body 100 does not act.

Therefore, the positioning in the clockwise rotation direction along the cylindrical portions 14a and 15a of the cartridge 2 can be performed with the regulating and abutting portions 16a and 17a of the cartridge 2 abutting on the points of the fixed member 101 and 102 of the main body 100 by pushing the pushed portion 13d of the cartridge 2 with the pushing member 160. Hence, when a large amount of toner in the developing unit 20 of the cartridge 2 is consumed or the cartridge 2 is not given drive transmission (rotation drive) from the main body 100, the regulating and abutting portions 16a and 17a owing to the moment in the direction shown by an arrow Y by the connector 140 can prevent the separation of points of the fixed members 101 and 102 or the occurrence of contact pressure shortage of the connector 140 to the contact portion 62 of the memory tag 60.

That is, it is possible to increase the reliability of electric connection of the electrical contact 42 and contact portion 62 regardless of the consumption of toner in the cartridge 2, and further, even when the cartridge 2 is not given the drive transmission from the main body 100.

This is effective for a mass cartridge where the variation of weight of the toner in the cartridge 2 is large, or for acceleration of the communication between the memory tag 60 and a control unit (not shown) of the main body 100.

Hence, as explained above, the present invention exhibits such effects that are described as follows.

Electrical connection of a cartridge electrical contact of a process cartridge and a main body electrical contact provided in a main body of an electrophotographic image forming apparatus can be achieved in simple structure.

In addition, it is possible to surely and stably contact the main body electrical contact provided in an electrophotographic image forming apparatus to the cartridge electrical contact portion when the process cartridge is attached to the main body of the electrophotographic image forming apparatus.

Furthermore, a main body electrical contact, provided in a main body of an electrophotographic image forming apparatus, can abut on a cartridge electrical contact without contacting to a frame body of the process cartridge, and a main board except the cartridge electrical contact when the process cartridge is attached to the above-described main body of the electrophotographic image forming apparatus.

Moreover, it becomes possible to realize the miniaturization and space-saving of the process cartridge and the main body of the electrophotographic image forming apparatus.

In addition, it is possible to surely and stably contact the main body electrical contact provided in an electrophotographic image forming apparatus to the cartridge electrical contact portion of a main board when the process cartridge is attached to the main body of the electrophotographic image forming apparatus.

Furthermore, it is possible to increase the positional accuracy of contact of the main body electrical contact provided in an electrophotographic image forming apparatus to the cartridge electrical contact portion, provided in the process cartridge, when the process cartridge is attached to the main body of the electrophotographic image forming apparatus.

Moreover, a main body electrical contact, provided in a main body of an electrophotographic image forming apparatus, can smoothly abut on a cartridge electrical contact portion without a shock when the process cartridge is attached to the main body of the electrophotographic image forming apparatus.

What is claimed is:

1. A process cartridge detachable from a main body of an electrophotographic image forming apparatus including a main body electrical contact and main body pushing means, comprising:
an electrophotographic photosensitive body drum;
process means for acting on the electrophotographic photosensitive body drum;
a frame body;
a memory element for storing information;
a cartridge electrical contact portion that is electrically connected to the memory element, and is electrically connected to the main body electrical contact when the process cartridge is attached to the main body of the electrophotographic image forming apparatus;
a main board provided at a portion of the frame body, having the memory element and the cartridge electrical contact portion; and
a pushed portion provided at a portion of the frame body, and in which the main body electrical contact and the cartridge electrical contact portion are pushed in the direction of being electrically connected by the main body pushing means when the process cartridge is attached to the main body of the electrophotographic image forming apparatus.

2. A process cartridge according to claim 1, wherein the main board is provided in a top face side of the frame body, and the pushed portion is provided in a bottom face side of the frame body□@when the process cartridge is attached to the main body of the electrophotographic image forming apparatus.

3. A process cartridge according to claim 1, further comprising:
a positioning member that projects from the frame body in one end side and another end side of the electrophotographic photosensitive body drum in the direction of an axial line and is provided on a line coaxial with the axial line, and serves to guide the process cartridge when the process cartridge is attached to the main body of the electrophotographic image forming apparatus, and positioning the process cartridge when the process cartridge is attached to the main body of the electrophotographic image forming apparatus; and
a rotation regulating and abutting portion for abuting on a main body rotation regulating member provided in the main body of the electrophotographic image forming apparatus, the rotation body being provided on the frame body, and for regulating the process cartridge so as to prevent rotateing around the positioning member when the process cartridge is attached to the main body of the electrophotographic image forming apparatus and the pushed portion is pushed by the main body pushing means.

4. A process cartridge according to claim 2, wherein the pushed portion is provided in a bottom face side of the frame body that corresponds to a position in the direction of the axial line in which the main board is provided.

5. A process cartridge according to any one of claims 1 to 4, wherein an amount of a moment of the electrophotographic photosensitive body drum around an axial line in the pushed portion is larger than an amount of a moment around the axial line in the main board when the process cartridge is attached to the main body of the electrophotographic image forming apparatus.

6. A process cartridge that is detachable from a main body of an electrophotographic image forming apparatus including a main body electrical contact and a main body abutting member, comprising:
an electrophotographic photosensitive body drum;
process means for acting on the electrophotographic photosensitive body drum;
a frame body;
a memory element for storing information;
a cartridge electrical contact portion that is electrically connected to the memory element, and is electrically connected to the main body electrical contact when the process cartridge is attached to the main body of the electrophotographic image forming apparatus;
a main board provided at a portion of the frame body, having the memory element and the cartridge electrical contact portion;
a cartridge abutting portion provided on the same side as the main board with projecting from the frame body, and guides the main body electrical contact to the cartridge electric contact portion with contacting to the main body abutting member when the process cartridge is attached to the main body of the electrophotographic image forming apparatus; and
an inclined plane provided in an upstream side of the cartridge abutting portion in a attachment direction in which the process cartridge is attached to the main body of the electrophotographic image forming apparatus, and serves to electrically connect the main body electrical contact, guided by the main body abutting member, to the cartridge electrical contact portion when the process cartridge is attached to the main body of the electrophotographic image forming apparatus.

7. A process cartridge according to claim 6, wherein the cartridge abutting portion is provided together in parallel to the main board in a direction orthogonal to the attachment direction, and an upstream edge of the inclined plane in the attachment direction is located in a position corresponding within length of the cartridge electrical contact portion in the attachment direction.

8. A process cartridge according to claim 6, wherein the main board is provided in a mounting portion projecting from a top face side of the frame body when the process cartridge is attached to the main body of the electrophotographic image forming apparatus, and height of the cartridge abutting portion is height at which each clearance is generated between the main body contact portion, the frame body, and the main board when the cartridge abutting portion abuts on the main body abutting member.

9. A process cartridge according to any one of claims 6 to 8, wherein the main board is provided in a mounting portion projecting from a top face side of the frame body when the process cartridge is attached to the main body of the electrophotographic image forming apparatus, and height of the mounting portion is height at which a clearance is generated between the main body abutting member and a surface of the frame body when the process cartridge is attached to the main body of the electrophotographic image forming apparatus and the main body electrical contact electrically abuts on the cartridge contact portion.

10. A process cartridge according to claim 6, further comprising:
a cartridge supporting member positioning portion for positioning the main body electrical contact in a direction orthogonal to the attachment direction by engaging with a main body supporting member positioning portion provided in a main body electrical contact supporting member having the main body electrical contact;
a cartridge attachment guide portion for guiding the process cartridge in the orthogonal direction by engaging with a main body cartridge attachment guide portion provided in the main body of the electrophotographic image forming apparatus; and
a groove portion provided in the attachment direction, and in which the cartridge supporting member positioning portion and the cartridge attachment guide portion are installed in parallel.

11. A process cartridge according to claim 10, further comprising: a rotation regulating and abutting portion that is provided in a bottom of the groove portion, and abuts on a main body rotation regulating member provided in the main body of the electrophotographic image forming apparatus, and regulates the process cartridge to rotate in the same direction as a rotary direction of the electrophotographic photosensitive body drum when the process cartridge is installed in the attachment position and the electrophotographic photosensitive body drum is given rotation drive from the main body of the electrophotographic image forming apparatus.

12. An electrophotographic image forming apparatus that has a detachable process cartridge and forms an image in a recording medium, comprising:
(i) a main body electrical contact;
(ii) main body pushing means;
(iii) attachment means for detachably attaching a process cartridge comprising: an electrophotographic photosensitive body drum; process means of acting on the electrophotographic photosensitive body drum; a frame body; a memory element storing information; a cartridge electrical contact portion that is electrically connected to the memory element, and is electrically connected to the main body electrical contact when the process cartridge is attached to the main body of the electrophotographic image forming apparatus; a main board that is provided in the frame body, and has the memory element and the cartridge electrical contact portion; and a pushed portion that is provided in the frame body, and in which the main body electrical contact and the cartridge electrical contact portion are pushed in the direction of being electrically connected by the main body pushing means when the process cartridge is attached to the main body of the electrophotographic image forming apparatus; and
(iv) conveying means for conveying the recording medium.

13. An electrophotographic image forming apparatus that has a detachable process cartridge and forms an image in a recording medium, comprising:
(i) a main body electrical contact;
(ii) a main body electrical contact supporting member for supporting the main body electrical contact;
(iii) a main body abutting portion provided in the main body electrical contact supporting member;
(iv) attachment means for detachably attaching a process cartridge comprising: an electrophotographic photosensitive body drum; process means of acting on the electrophotographic photosensitive body drum; a frame body; a memory element storing information; a cartridge electrical contact portion that is electrically connected to the memory element, and is electrically connected to the main body electrical contact when the process cartridge is attached to the main body of the electrophotographic image forming apparatus; a main board that is provided in the frame body, and has the memory element and the cartridge electrical contact portion; a cartridge abutting portion that is provided in the same side as the main board with projecting from the frame body, and guides the main body electrical contact to the cartridge electric contact portion with contacting to the main body abutting member when the process cartridge is attached to the main body of the electrophotographic image forming apparatus; and an inclined plane that is provided in an upstream side of the cartridge abutting portion in an attachment direction in which the process cartridge is attached to the main body of the electrophotographic image forming apparatus, and serves to electrically connect the main body electrical contact, guided by the main body abutting member, to the cartridge electrical contact portion when the process cartridge is attached to the main body of the electrophotographic image forming apparatus; and
(v) conveying means for conveying the recording medium.

14. An electrophotographic image forming apparatus according to claim 13, further comprising:
a main body supporting member positioning portion, provided on the main body electrical contact supporting member, for positioning the main body electrical contact in the orthogonal direction by engaging with a cartridge supporting member positioning portion of a groove provided in the process cartridge in the attachment direction; and
a main body cartridge attachment guide portion, provided on the main body, for guiding the process cartridge in the orthogonal direction by engaging with a cartridge attachment guide portion of the groove.

15. An electrophotographic image forming apparatus according to claim 13, further comprising: a rotation regulating that is provided in a bottom of the main body and abuts on a bottom of the groove, and regulates the process cartridge to rotate in the same direction as a rotary direction of the electrophotographic photosensitive body when the process cartridge is installed in the attachment position and the electrophotographic photosensitive body drum is given rotation drive from the main body of the electrophotographic image forming apparatus.
